(19) United States
(12) Patent Application Publication
(10) Pub. No.: US 2017/0255242 A1
(43) Pub. Date: Sep. 7, 2017

(54) SYSTEM AND METHOD FOR SUPPLYING POWER TO AN ELECTRONIC DEVICE

(71) Applicant: Gridless Power Corporation, Collingswood, NJ (US)

(72) Inventors: Jason HALPERN, Collingswood, NJ (US); Erik DEBRUN, San Francisco, CA (US)

(21) Appl. No.: 15/528,491

(22) PCT Filed: Nov. 20, 2015
(86) PCT No.: PCT/US2015/061993

§ 371 Date: May 19, 2017

Related U.S. Application Data
(60) Provisional application No. 62/082,414, filed on Nov. 20, 2014.

(51) Int. Cl. G06F 1/26; H02J 1/10; H02J 7/34; H02J 3/38; B60R 16/02

(52) U.S. Cl. CPC G06F 1/263; G06F 1/266; H02J 3/383; H02J 3/386; B60R 16/02; H02J 7/34; H02J 1/10

(57) ABSTRACT

A system and method is disclosed for supplying power to an electronic device from a plurality of different power sources, comprising a plurality of input power interfaces, a plurality of power adapters connected to the input power interfaces, and at least one power bus connected to the power adapters, wherein any of the power sources may be connected to any one or more of the input power interfaces. Devices powered by a plurality of different power sources are also described.

### CROSS-REFERENCE TO RELATED APPLICATIONS

This application claims the benefit of U.S. Provisional Application No. 62/082,414, filed on Nov. 20, 2014, the entire content of which is incorporated herein by reference.

### FIELD OF THE INVENTION

This invention relates generally to power electronics, and more specifically to electrical systems.

### BACKGROUND

Electronic devices are a core component of everyday life. Power supply systems bring necessary power from an outside source into an electronic device. They can range from AC adaptors for laptops, to a USB wall adaptor for charging a cellphone or tablet, to many other forms. Electronic devices can include external electronics and internal electronics. For example the USB wall adaptor may include external electronics, for example, an external AC/DC converter to convert the inputted power to a form compatible with the device, and/or internal electronics, for example, a DC/DC converter to adjust the converted power to a voltage level usable by the device.

There is a large body of art relating to methods of power supply system design. In general, the art focuses on refining the existing paradigms, increasing efficiency, reducing manufacturing costs, etc.

The majority of electronic devices have a single internal power supply connected to a single power input. For example, a cellphone may only be able to bring in power through its USB port, or a laptop my only be able to bring in power through a specific charging port. External power supplies must be used to convert a power source into a form that can be accepted by the internal power supply. In general, this is an adequate solution as the use cases for these devices are not highly variable.

Some electronic devices must be able to accept power inputs from a variety of power sources with variability in availability, type, and power output capability. For example, a mobile battery system for emergencies might be configured to be charged by whatever power source is available, for example, a wall outlet, a generator, a solar panel, a wind turbine, etc.

Solutions that rely on a single power input are limited by the capabilities of that converter. For example, an electronic device that uses a solar charge controller as its single input will have power input capability that is limited by the throughput of that converter. It is often the case that solar charging is the driving factor of the power supply system, in these cases the power input from another energy source, for example a wall outlet, is limited.

Solutions that rely on multiple power inputs provide means to decouple the different charging methods. In this case, the electronic device in the previous example may have one power input for a wall outlet and another power input for a solar panel. The two inputs may include different electronics and connectors to account for the differences between the power sources.

This approach offers increased flexibility, but has several problems.

First, additional power input capability is often expensive from cost, weight, size, and complexity perspectives. A device featuring a separate, correctly sized power input system for every possible power source would be prohibitively expensive, large, heavy, and complicated.

Second, physical connectors are often complex and expensive. Having a specific connector for each of a plurality of possible power sources results, in many cases, to connectors remaining unused. This unnecessarily increases the cost to manufacture the device.

Third, a variety of different connectors can be difficult for a user to understand. Often it requires detailed labeling and specific instructions to ensure that the user knows where to connect each power source. This may result in user error that is potentially dangerous to the user and/or destructive to the device.

What is needed is a power supply system with a combination of internal and external power supplies that is easier to use, more flexible, and more cost effective than existing solutions.

### SUMMARY OF THE INVENTION

The present invention describes an advantageous system and method for supplying power to an electronic device from a plurality of different power sources in a way that is simple for a user to configure, can easily accommodate a variety of power sources, and is cost effective to implement. The present invention also describes an advantageous device powered by a plurality of different power sources.

One advantage of the present invention is that it simplifies user interaction with the power system. This not only makes the power system easier and faster to use, it reduces the likelihood of user error by eliminating possible mistakes.

Another advantage of the present invention is that it increases the power input flexibility of electronic devices, allowing for dynamic reallocation of charger electronics between different power sources through a simple user interaction.

The use of multiple, smaller, similar internal power converters vs. larger monolithic converters allows for dynamic reallocation of converter resources to different power sources, increasing redundancy, and greatly simplifying the use of the device.

External power supplies that connect to a plurality of similar power converters allow for smaller connectors, the dynamic reallocation of converter resources to different power sources, charging of multiple devices from a single power adaptor, and simplification of the use of the device.

### BRIEF DESCRIPTION OF THE DRAWINGS

Aspects, features, benefits, and advantages of the present invention will be apparent with regard to the following description and accompanying drawings, of which:

FIG. 1 is a block diagram of an exemplary embodiment of the invention.

FIG. 2 is a block diagram of an alternative embodiment of the invention.

FIG. 3 is a block diagram of an alternative embodiment of the invention.

FIG. 4 is a block diagram of an alternative embodiment of the invention.

FIG. 5 is a block diagram of an alternative embodiment of the invention.

FIG. 6 is a block diagram of an alternative embodiment of the invention.

FIG. 7 is a block diagram of an alternative embodiment of the invention.

FIG. 8 is a block diagram of an alternative embodiment of the invention.

FIG. 9 is a block diagram of an alternative embodiment of the invention.

FIG. 10 is a block diagram of an alternative embodiment of the invention.

FIG. 11 is a block diagram of an alternative embodiment of the invention.

FIG. 12 is a block diagram of an alternative embodiment of the invention.

FIG. 13 is a block diagram of an alternative embodiment of the invention.

FIG. 14 is a block diagram of an alternative embodiment of the invention.

FIG. 15 is a block diagram of an alternative embodiment of the invention.

FIG. 16 is a block diagram of an alternative embodiment of the invention.

FIG. 17 is a block diagram of an alternative embodiment of the invention.

FIG. 18 is a block diagram of an alternative embodiment of the invention.

FIG. 19 is a block diagram of an alternative embodiment of the invention.

FIG. 20 is a block diagram of an alternative embodiment of the invention.

FIG. 21 is a block diagram of an alternative embodiment of the invention.

FIG. 22 illustrates an isometric view of an alternative embodiment of the invention.

FIG. 23 is a block diagram of an alternative embodiment of the invention.

FIG. 24 illustrates an isometric view of an alternative embodiment of the invention.

FIG. 25 is a block diagram of an alternative embodiment of the invention.

FIG. 26 illustrates an isometric view of an alternative embodiment of the invention.

FIG. 27 is a block diagram of an alternative embodiment of the invention.

FIG. 28 illustrates an isometric view of an alternative embodiment of the invention.

FIG. 29 is a block diagram of an alternative embodiment of the invention.

FIG. 30 illustrates an isometric view of an alternative embodiment of the invention.

FIG. 31 is a block diagram of an alternative embodiment of the invention.

FIG. 32 is a block diagram of an alternative embodiment of the invention.

FIG. 33 is a block diagram of an alternative embodiment of the invention.

FIG. 34 is a block diagram of an alternative embodiment of the invention.

FIG. 35 illustrates an isometric view of an alternative embodiment of the invention.

FIG. 36 is a block diagram of an alternative embodiment of the invention.

FIG. 37 is a block diagram of an alternative embodiment of the invention.

FIG. 38 is a block diagram of an alternative embodiment of the invention.

FIG. 39 is a block diagram of an alternative embodiment of the invention.

FIG. 40 is a block diagram of an alternative embodiment of the invention.

FIG. 41 is a block diagram of an alternative embodiment of the invention.

FIG. 42 is a block diagram of an alternative embodiment of the invention.

FIG. 43 is a block diagram of an alternative embodiment of the invention.

### DETAILED DESCRIPTION

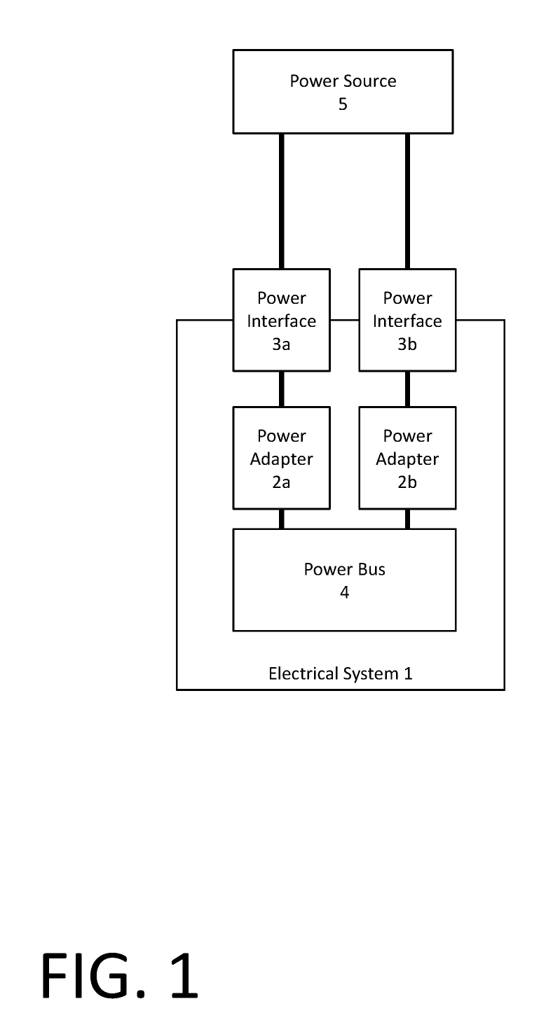

The system of the invention comprises an electrical system containing one or a plurality of power adapters. Each power adapter is connected to a power interface and a power bus. One or a plurality of power sources may be connected to one or a plurality of power interfaces. FIG. 1 illustrates an exemplary embodiment of the invention in which electrical system 1 contains a plurality of power adapters 2a and 2b. Power adapters 2a and 2b are connected to power interfaces 3a and 3b, and to power bus 4, and power source 5 is connected to power interfaces 3a and 3b.

The electrical system 1 may be any collection of hardware and/or software in which the flow of electrical energy causes a physical, electrical, or digital change.

Power adapters 2a and 2b may be any collection of hardware and/or software that receive an input of electrical energy of one set of characteristics and outputs electrical energy of a different set of characteristics. For example, at least one of power adapters 2a and 2b may be a battery charger that automatically converts inputted DC power into the correct form of power to properly charge a battery. In an alternative embodiment, at least one of power adapters 2a and 2b may be able to automatically draw the maximum power point for a given power source.

Power interfaces 3a and 3b may be any components of combination of components that connect electrical systems and/or an electrical system to a power source including, but not limited to, a connector, a transmitter and receiver for wirelessly transferring power, a plug, or any other such component of combination of components.

Power bus 4 may be any form of electrical or mechanical system that connects two or more components within electrical system 1 including, but not limited to, a bus bar, a wire, or a printed circuit board.

Power source 5 may be any source of electrical potential including, but not limited to, an AC power source such as an AC grid connection or an AC generator, or a DC power source such as a a solar panel, a turbine, vehicle power system, and energy storage element, a DC grid connection, or a DC generator. An AC generator or DC generator may be a combustion generator, a hydro-electric generator, a wind generator, a solar cell, a fuel cell, or any other form of generator. A power source may include one or more of the examples provided as well as others.

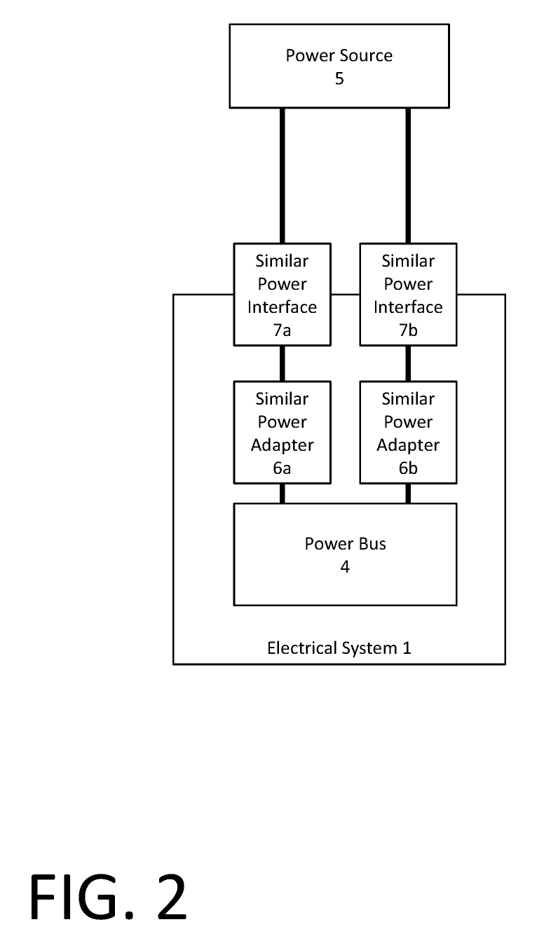

FIG. 2 illustrates an alternative embodiment of the invention in which a plurality of power adapters 6a and 6b are similar power adapters and a plurality of power interfaces 7a and 7b are similar power interfaces.

The plurality of power adapters may be considered similar power adapters if each of the power adapters is capable of receiving electrical energy of a similar range of characteristics such as, for example, voltage ranges and current capacities, and outputting electrical energy of a similar range of characteristics. For example, two DC-DC converters with similar input voltage ranges and current capacities and similar output voltage ranges and current capacities may be considered similar power adapters.

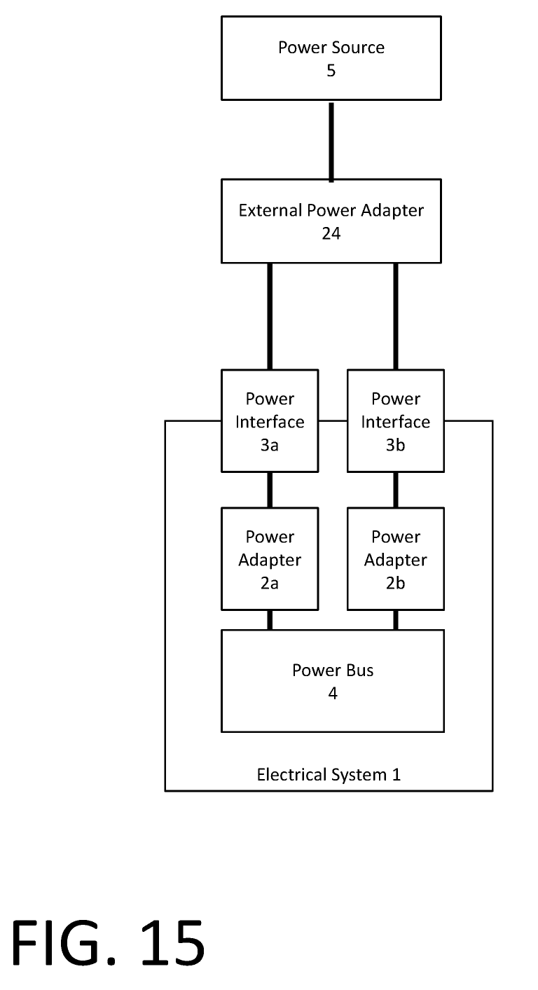

The plurality of power interfaces may be considered similar power interfaces if they can interface with one or more similar power sources and/or similar external power adapters (as shown in FIG. 15). For example, the similar power interfaces 7a and 7b in FIG. 2 may be connectors that can mate with similar external connectors or systems for transferring wireless power that can interface with other external systems for transferring wireless power.

In an alternative embodiment, the power sources that can connect to one of the power interfaces may connect to any of the other power interfaces. In addition, power from one of the power sources that can be processed by one of the power adapters may be able to be processed by any of the other power adapters.

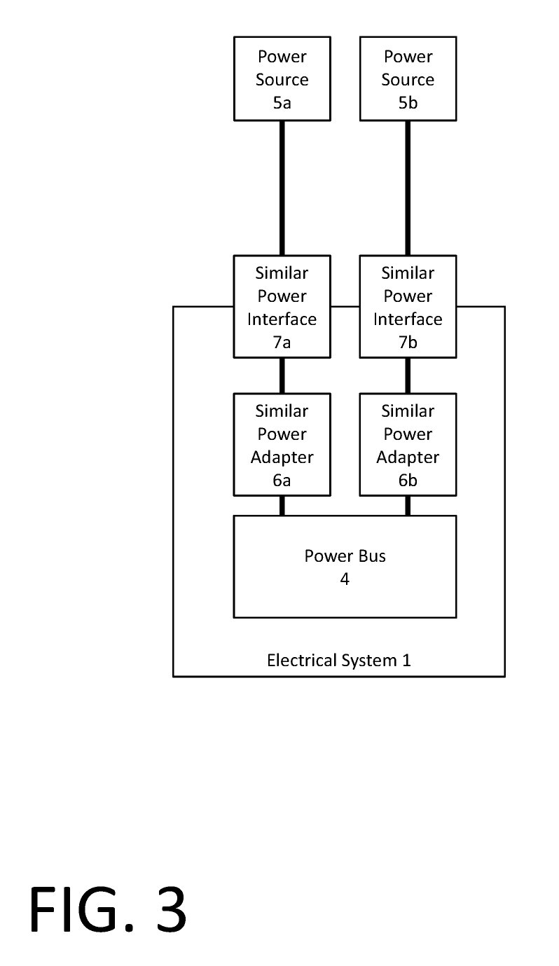

As illustrated in FIG. 3, the similar power interfaces 7a and 7b can each be connected to separate power sources 5a and 5b. Any number and combination of power sources connected to one or more similar power interfaces is possible.

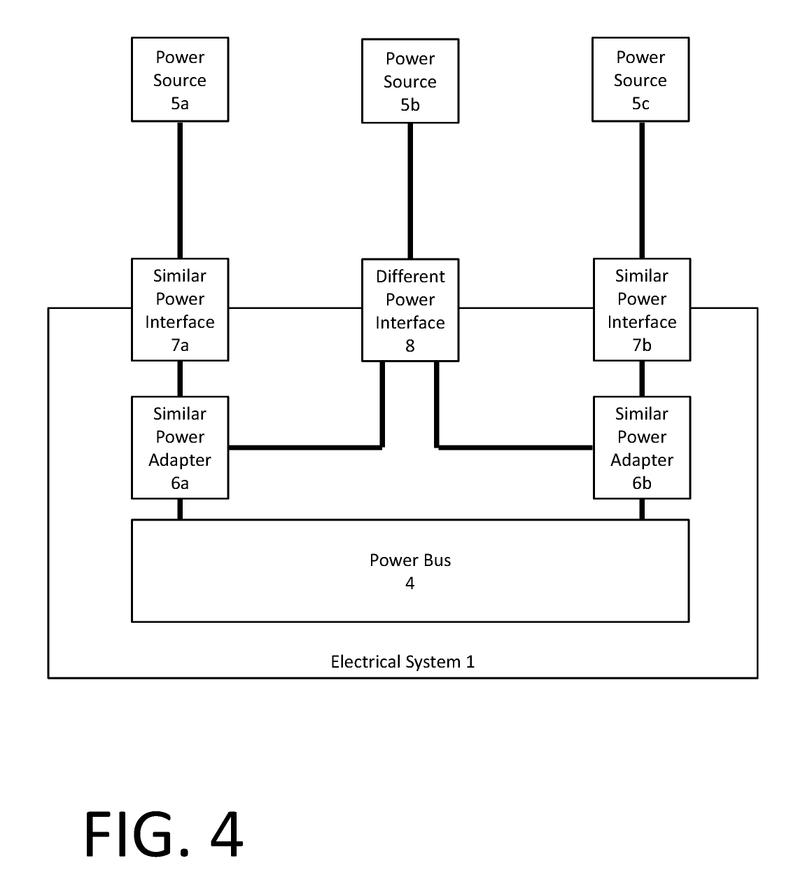

FIG. 4 illustrates an alternative embodiment in which a different power interface 8 is connected to a plurality of similar power adapters 6a and 6b, and to power source 5b. The similar power adapters 6a and 6b are also connected to a plurality of similar power interfaces 7a and 7b. Similar power interfaces 7a and 7b are also connected to power sources 5a and 5c. One or a plurality of different power interfaces may also be connected to one or a plurality of similar power adapters.

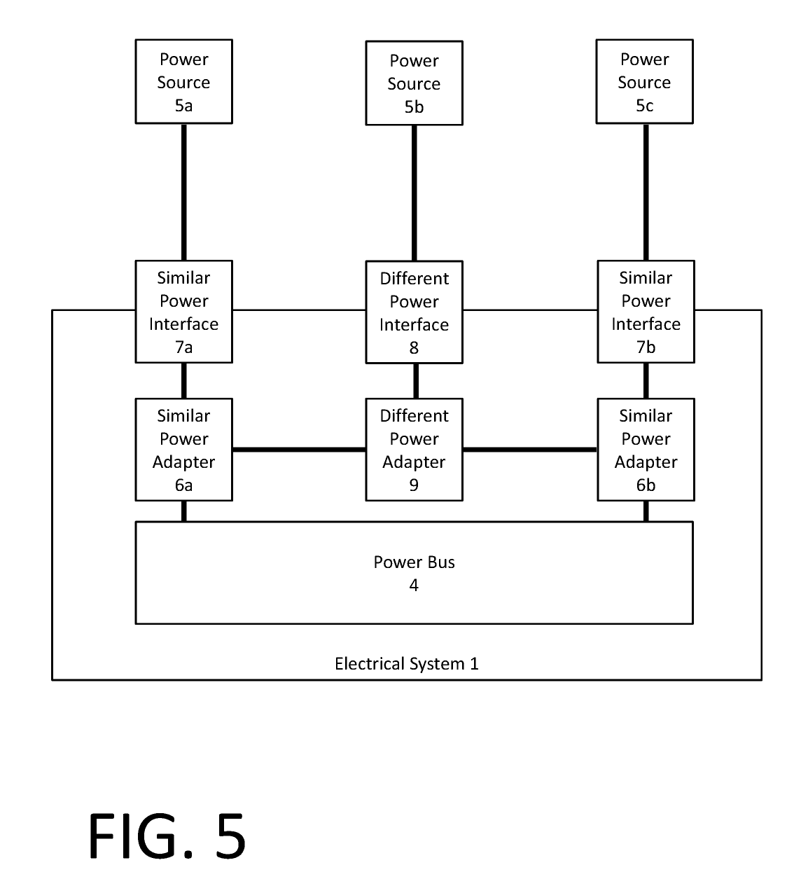

FIG. 5 illustrates an alternative embodiment in which a different power interface 8 is connected to a different power adapter 9. The different power adapter 9 is connected to a plurality of similar power adapters 6a and 6b. One or a plurality of different power interfaces may also be connected to one or a plurality of different power adapters, and the one or a plurality of different power adapters may be connected to one or a plurality of similar power adapters. The different power adapter 9 may also be connected to the power bus 4.

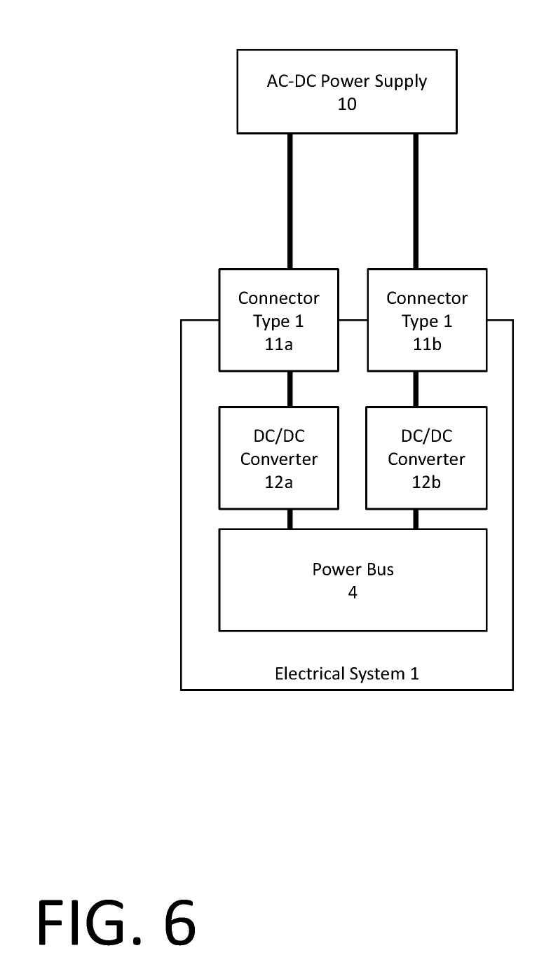

FIG. 6 illustrates an alternative embodiment. In this embodiment, an AC-DC Power Supply 10 has a plurality of output cables with connectors of a similar type. The cables are attached to a plurality of Connector Type 1s 11a and 11b. Power travels through the connectors 11a and 11b, through the DC/DC converters 12a and 12b, to the power bus 4. The DC/DC converters 12a and 12b draw power from the AC-DC power supply 10 and output power to the power bus 4.

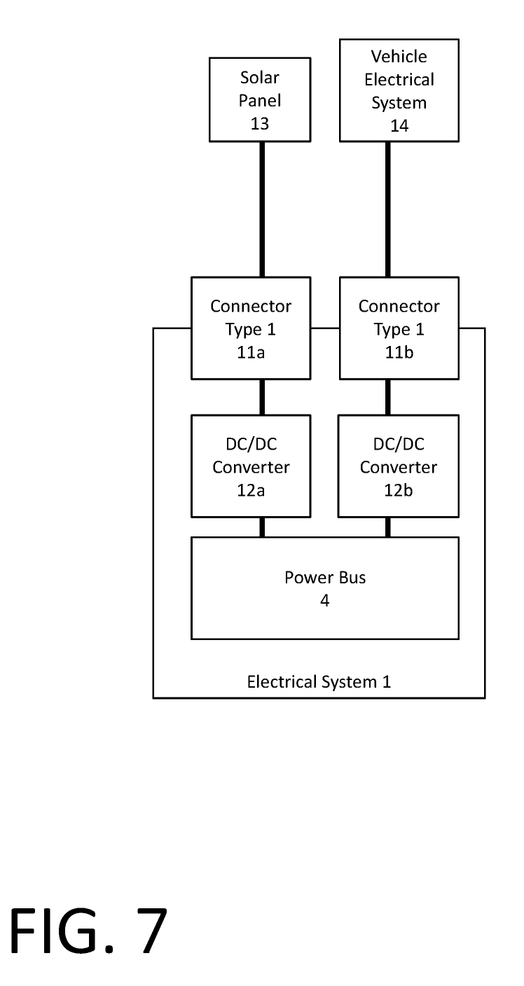

FIG. 7 illustrates an alternative embodiment in which a solar panel 13 is attached to a Connector Type 1 11a. In addition, a Vehicle Electrical System 14 is attached to another Connector Type 1 11b. One of the DC/DC converters 12a would draw power from the solar panel 13, and the other DC/DC converter 12b would draw power from the vehicle electrical system 14.

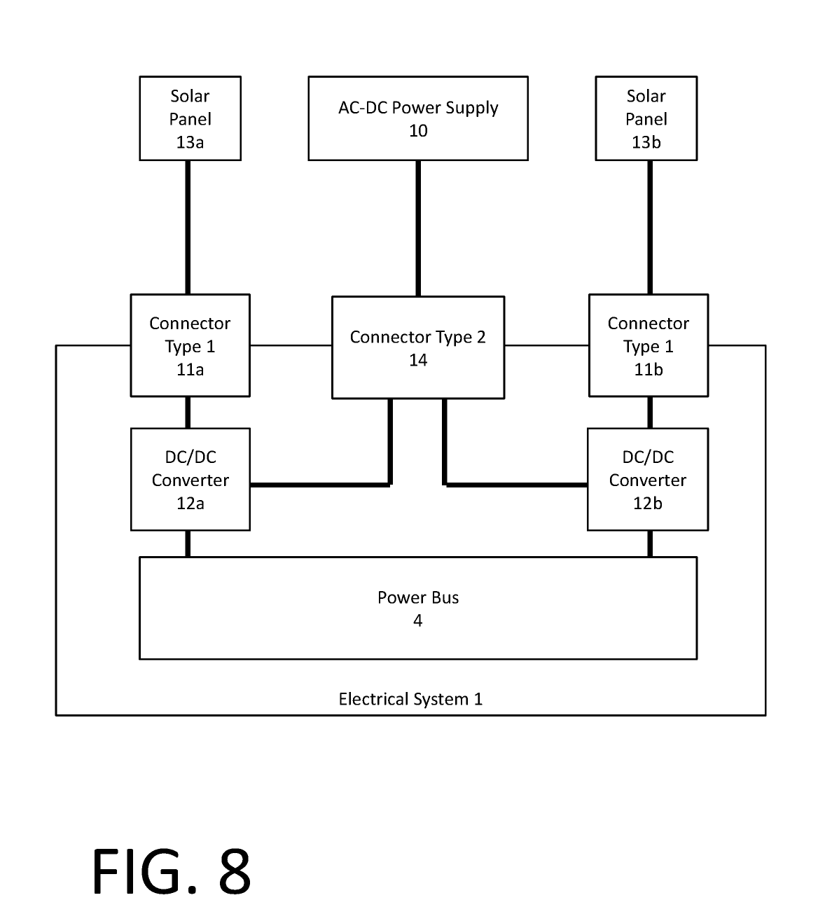

FIG. 8 illustrates an alternative embodiment in which an AC/DC power supply 10 is attached to a connector type 2 14. Power is then fed into a plurality of DC/DC converters 12. Power may be fed into one or a plurality of DC/DC converters.

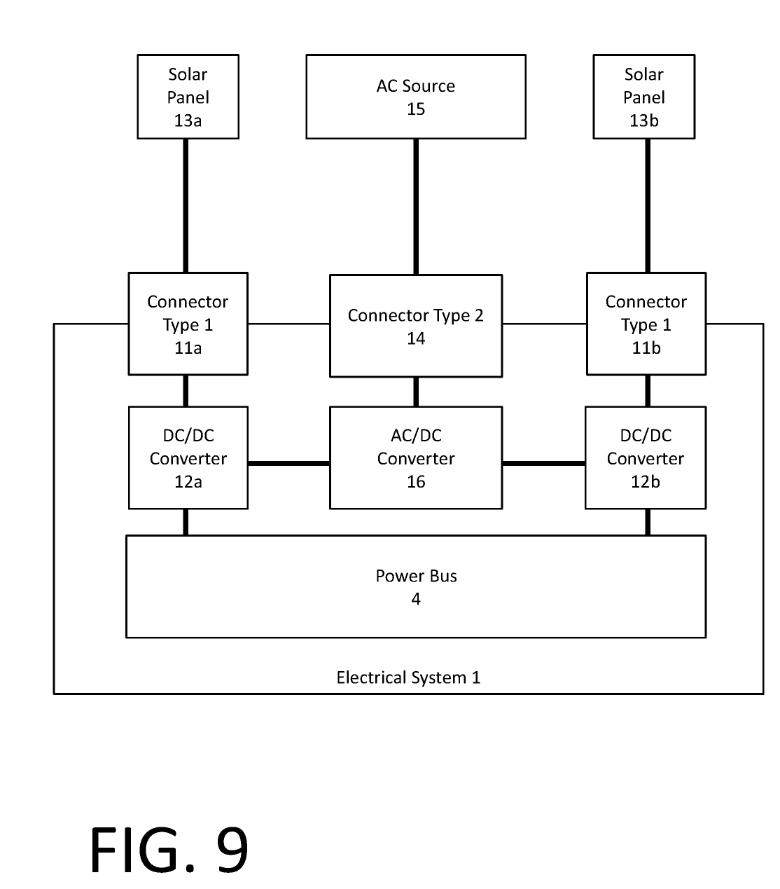

FIG. 9 illustrates an alternative embodiment in which an AC source 15 is connected directly to a connector type 2 14. The AC power is then fed into an AC/DC converter 16, and then into a plurality of DC/DC converters 12a and 12b. AC power may be fed into an AC/DC converter and then into one or a plurality of DC/DC converters.

It will be understood that in any of the foregoing or similar embodiments, the type, quantity, and configuration of the power sources, power interfaces, and power adaptors may vary.

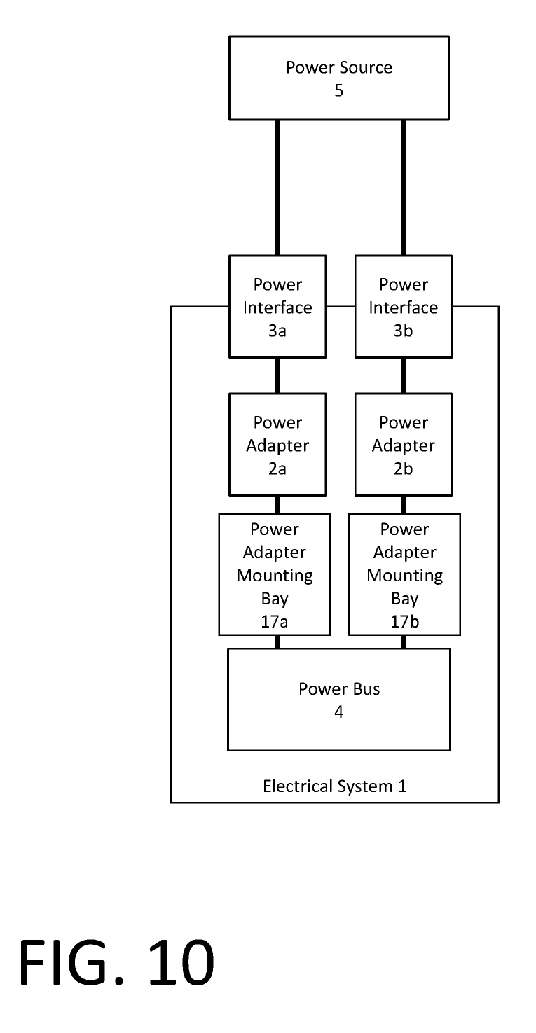

FIG. 10 illustrates an alternative embodiment in which one or a plurality of power adapters 2a and 2b may be attached to the power bus 4 through power adapter mounting bays 17a and 17b. A power adapter mounting bay may be any mechanical or electrical component that connects a power adapter to the power bus. For example, the power adapter mounting bay may be a physical mounting point in the form of one or a plurality of holes and/or an electrical mounting point in the form of an electrical connector.

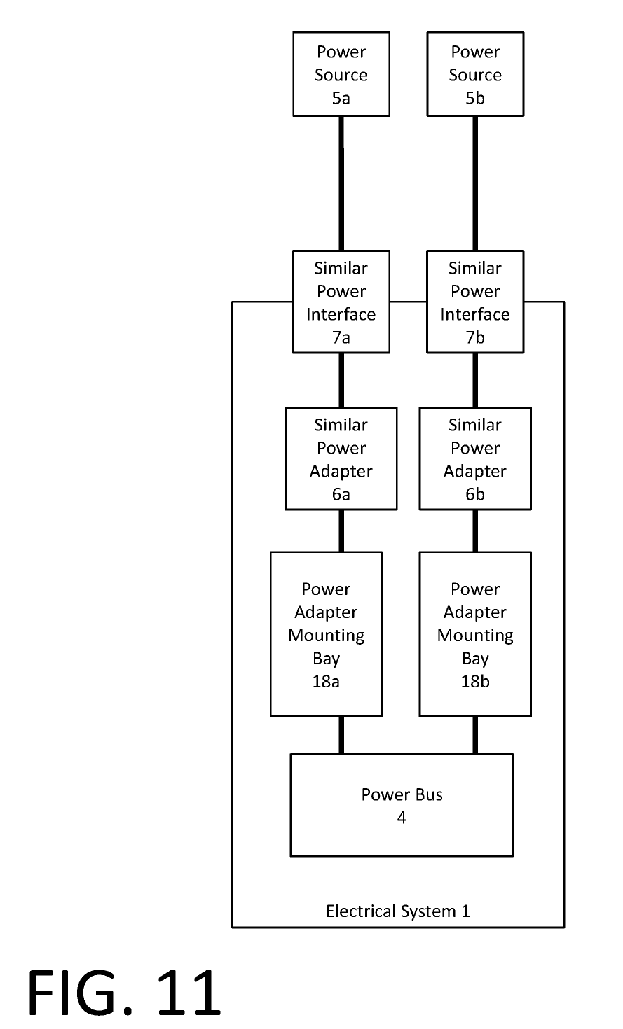

FIG. 11 illustrates an alternative embodiment, in which a plurality power adapter mounting bays 18a and 18b connect a plurality of similar power adapters 6a and 6b to the power bus 4. One or a plurality similar power adapter mounting bays may connect one or a plurality of similar power adapters to the power bus.

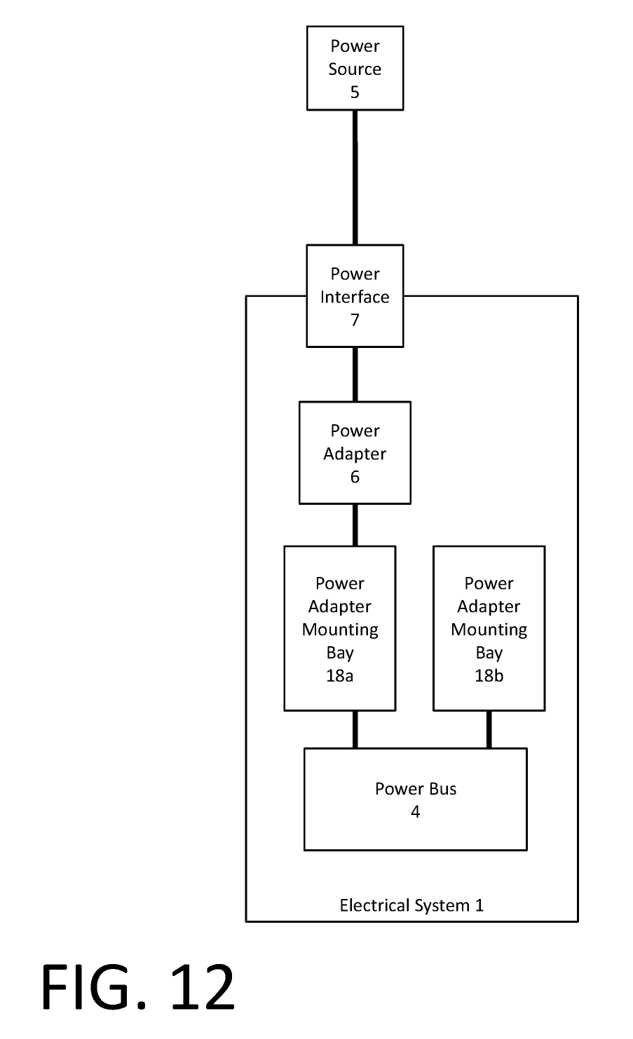

As shown in an alternative embodiment of the invention in FIG. 12, one or more power adapter mounting bays may not connect to a power adapter. In this embodiment, additional similar power adapters may be added. This modularity allows for the use of common electrical components across electronic systems that are sold as different products with different feature sets.

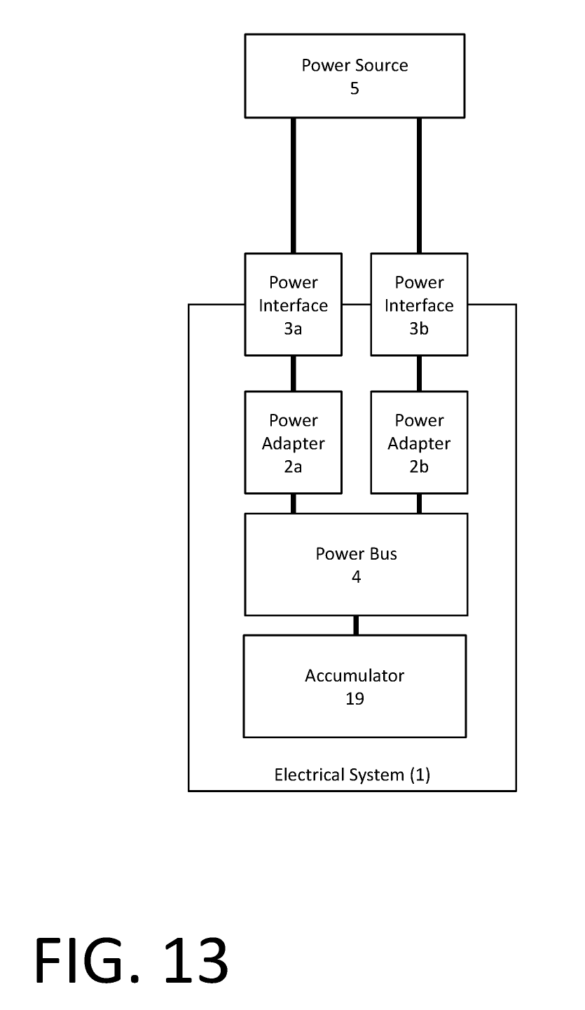

FIG. 13 illustrates an alternative embodiment in which the power bus 4 is connected to an accumulator 19. Accumulator 19 may be any device designed to store energy including, without limitation, a battery, a flywheel, a mainspring, a capacitor, or other energy storage components.

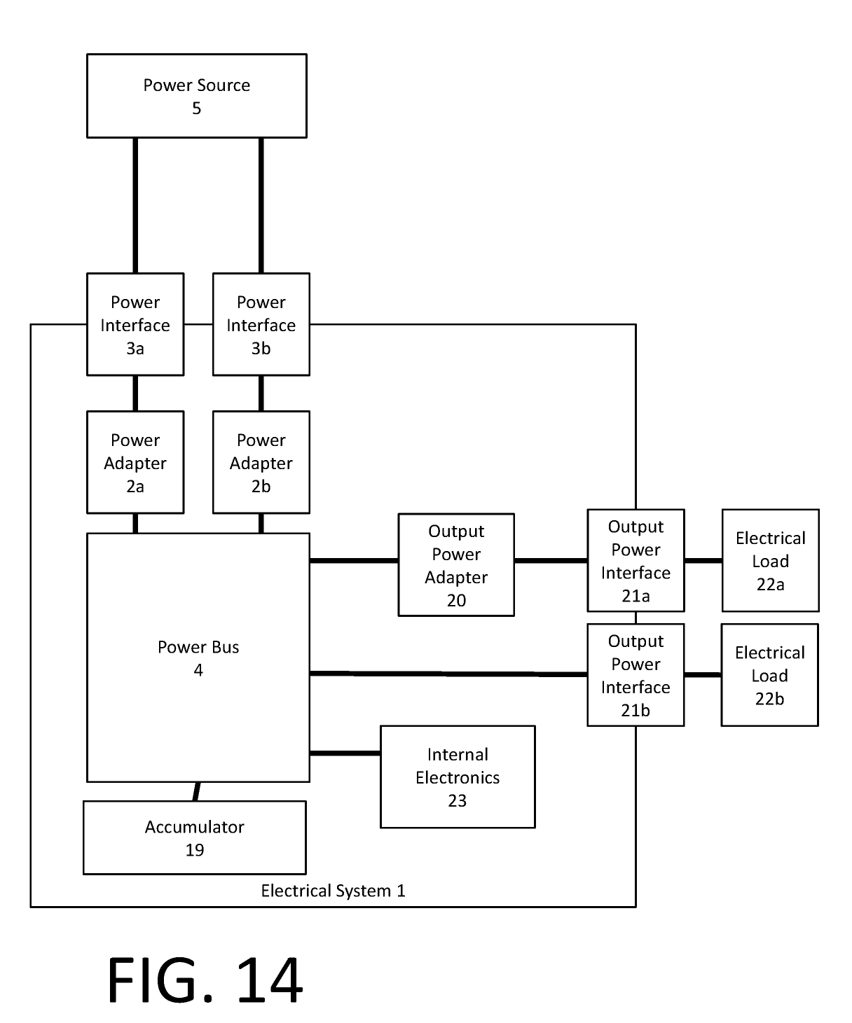

FIG. 14 illustrates an alternative embodiment in which an output power adapter 20 may connect the power bus 4 to an output power interface 21a. One or a plurality of output power adapters may connect the power bus to one or a plurality of output power interfaces. As shown in FIG. 14, power bus 4 is directly connected to output power interface 21b. The power bus may be directly connected to one or a plurality of output power interfaces. As further shown in FIG. 14, a plurality of electrical loads 22a and 22b are connected to the output power interfaces 21a and 21b. One or a plurality of electrical loads may be connected to the output power interfaces. As further shown in FIG. 14, internal electronics 23 is connected to the power bus 4. One or a plurality of internal electronics may be connected to the power bus. Internal electronics may be any form of electronics that converts, consumes, or otherwise uses power internal to the electrical system.

The output power adapter 20 may be any combination of hardware and/or software that alters the characteristics and/or controls power moving from the power bus 4 to the output power interface 21a. The output power adapter may be connected to one or a plurality or output power interfaces. In one embodiment, the output power adapter 20 may be a DC/AC inverter that converts DC power from the power bus 4 to AC power, and the output power interface 21a may be one or more wall outlets. The electrical load 22a in this embodiment may be any electrically powered device that may be plugged into a wall outlet. In an alternative embodiment, the electrical load may be any device that is powered by electricity. The output power adapter 20 may also be a DC/DC converter that converts DC power from the power bus 4 to a form of DC power that is compatible with USB electronics. The output power interface may be one or a plurality of USB ports and the electrical load may be USB electronics.

As illustrated in FIG. 15, power source 5 is connected to an external power adapter 24, which then in turn connects to a plurality of power interfaces 3a and 3b. Alternatively, a plurality of power sources may connect to one or a plurality of external power adapters, which then in turn may be connected to one or a plurality of power interfaces.

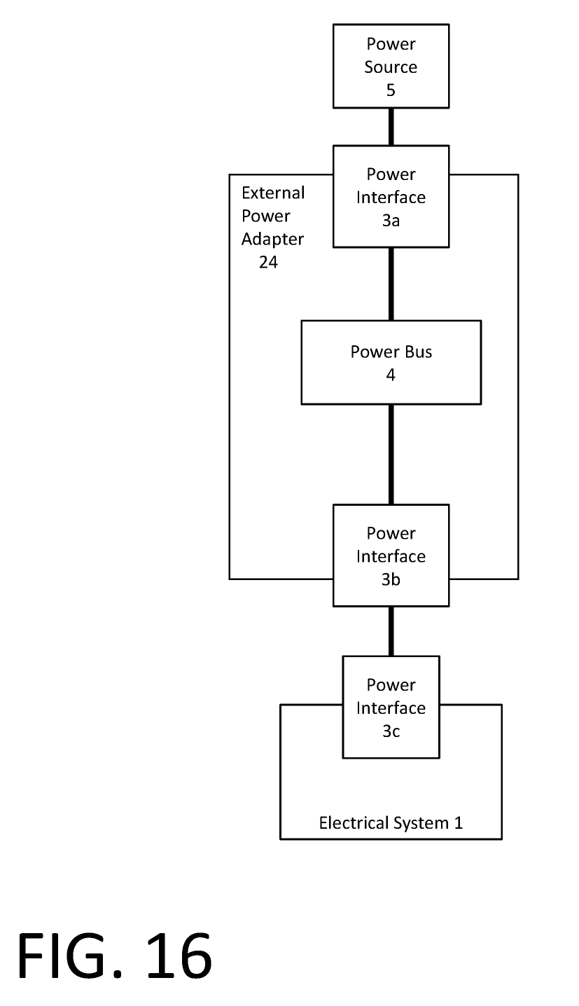

FIGS. 16-19 illustrate exemplary embodiments of the external power adapter 24. The external power adapter may contain one or a plurality of power interfaces connected to one or a plurality of external power adapters. The external power adapter may also consist of one or a plurality of power buses connected to one or a plurality of power interfaces. In alternative embodiments, the external power adapter may consist of any number, combination, and configuration of power interfaces, power adapters, and/or power interfaces.

FIG. 16 illustrates one embodiment of the external power adapter 24. This embodiment does not contain a power adapter. The power interface 3a is connected to another power interface 3b through power bus 4. Alternatively, the power interface may be connected to a plurality of other power interfaces through power bus. For example, the external power adapter 24 may be a cable that has one end that is a 12V accessory plug, the power interface that is connected to an automotive power system through a 12V accessory port. At the other end of the cable, the power bus may end in a connector that can interface with the electrical system through the other power interface. In another example, the external power adaptor may be a cable connected to a solar panel that ends in a connector that can interface with the electrical system.

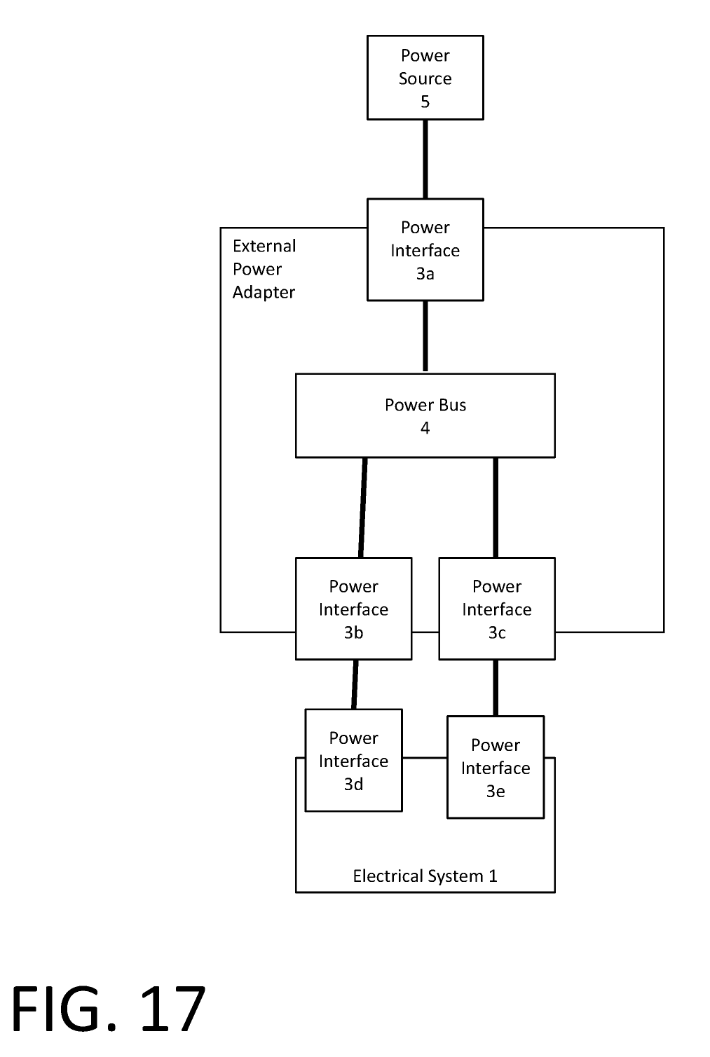

FIG. 17 illustrates an alternative embodiment of the external power adaptor 24. In this embodiment, power interface 3a is connected to a plurality of other power interfaces 3b and 3c through power bus 4. For example, the external power adaptor may be a cable that has one end that terminates in a connector to a car battery, the power interface that is connected to an automotive power system, through a direct connection with the battery. The other end of the cable may end in a plurality of connectors. As shown in FIG. 17, these connectors are power interfaces 3b and 3c that connect with power interfaces 3d and 3e on the electrical system 1.

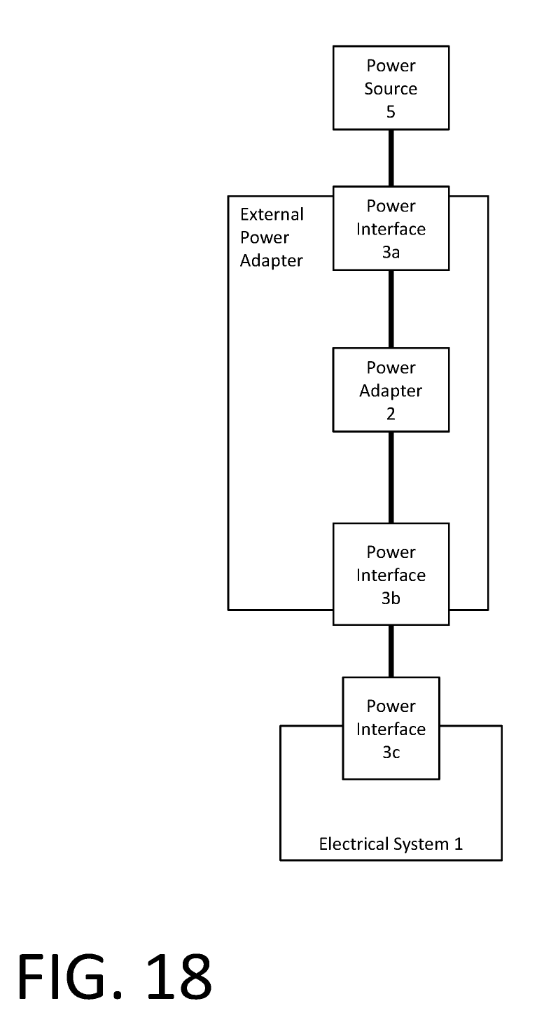

FIG. 18 illustrates an alternative embodiment of the external power adaptor 24. In this embodiment, a first power interface 3a is attached to a second power interface 3b through power adapter 2. For example the first power interface may be an AC power cable that is able to plug into a wall outlet, the power adapter may be an AC/DC converter, and the second power interface may be a cable ending in a connector that can mate with the power interface on the electrical system.

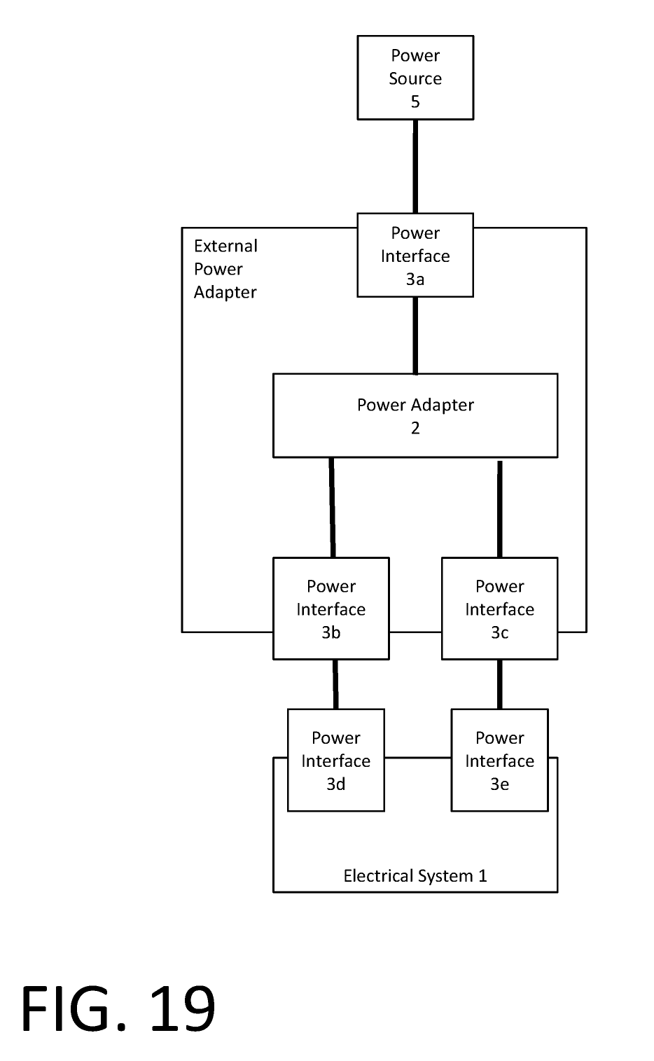

FIG. 19 illustrates an alternative embodiment of the external power adaptor 24. In this embodiment a first power interface 3a is attached to a plurality of other power interfaces 3b and 3c through power adapter 2. For example the first power interface may be an AC power cable that is able to plug into a wall outlet, the power adapter may be an AC/DC converter, and the other power interfaces may be more than one cable ending in a connector that can mate with more than one of the power interfaces on the electrical system.

In another example, the first power interface may connect to an automotive power system, the power adapter may be a DC/DC converter that converts the DC power from the automotive system to a different voltage, and the other power interfaces may be more than one cable ending in a connector that can mate with more than one power interfaces on the electrical system. In one example, the different voltage may be a higher voltage. For example, the 12V automotive power might be converted to a higher voltage, such as 40V. This higher voltage would allow the power adapters in the electrical system to draw more power in at the lower currents.

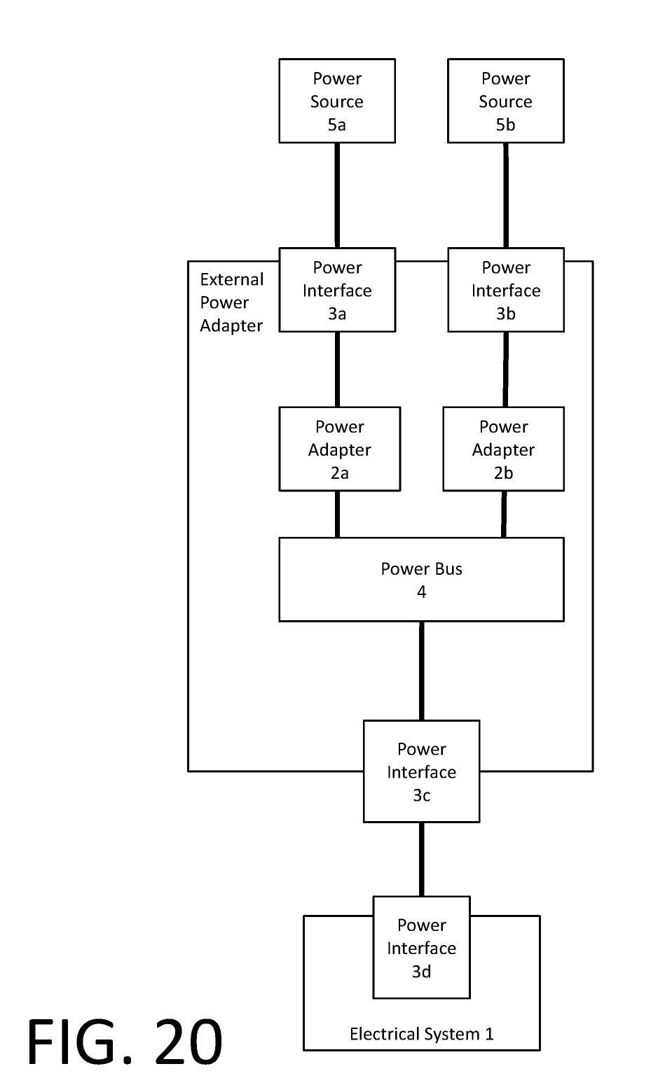

FIG. 20 illustrates an alternative embodiment of the external power adaptor 24. In this embodiment a plurality of first power interfaces 3a and 3b are attached to a power bus 4 through a plurality of power adapters 2a and 2b. The power bus may be connected to one or a plurality of other power interfaces. As shown in FIG. 20, power bus 4 is connected to power interfaces 3c. The power interfaces connected to the power sources may be more than one cable plugged into more than one solar panel, the power adapters may be DC/DC converters that convert the power from the solar panels to a different, common voltage, and the other power interfaces may be one or more cables ending in a connector that can mate with more than power interface on the electrical system.

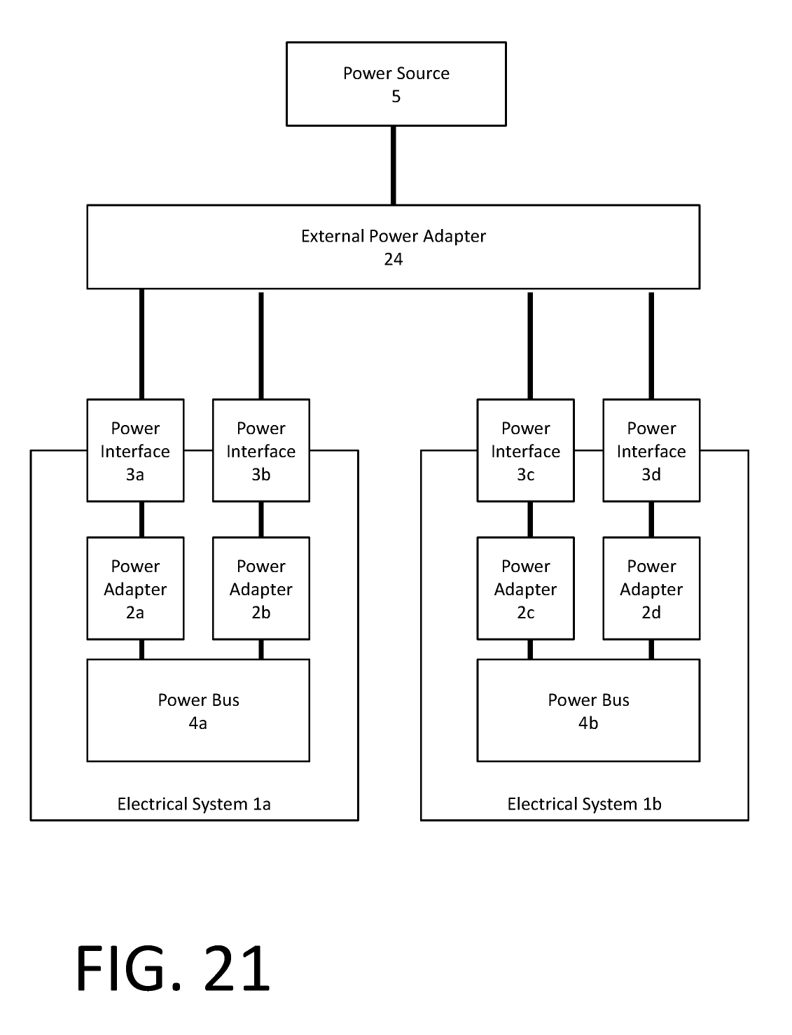

FIG. 21 illustrates an alternative embodiment of the invention. In this embodiment a single external power adapter 24 is attached to a plurality of power interfaces 3a, 3b, 3c, and 3d on a plurality of electrical systems 1a and 1b. For example the power source may be an AC power source, such as the grid or a generator. The external power adapter may be an AC/DC converter. The external power adapter 24 may have a plurality of cables with connectors that are able to mate with the power interfaces on the plurality of electrical systems 1a and 1b.

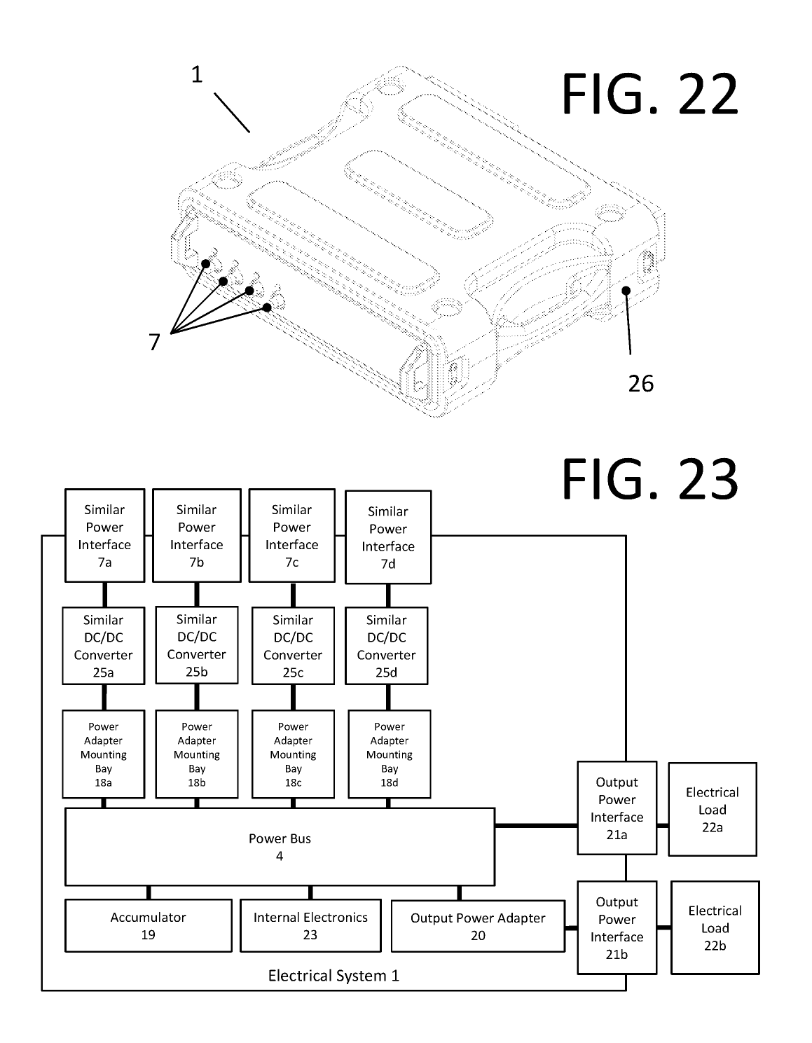

FIGS. 22 and 23 illustrate an alternative embodiment of the invention. In this embodiment, the electrical system 1 is housed in an enclosure 26. The electrical system may be a portable power storage and delivery system. It may use one or a plurality of a variety of external power adapters 24 to charge an energy storage element 19 from a one or a plurality of a variety of power sources 5. It may have a plurality of similar power interfaces 7. One or a plurality of the external power adapters may be able to interface with each of the similar power interfaces 7a, 7b, 7c, and 7d. For example, a user may plug a solar panel into one or more of the similar power interfaces. A user may also attach a desktop-style power supply to the similar power interface. A user may also attach an automotive attachment cable to the power adapters. Because the power interfaces 7a, 7b, 7c, and 7d and DC/DC converters 25a, 25b, 25c, and 25d are similar, the user does not need to think about which power interface to plug the external power adapter into. This is advantageous because it makes the electrical system 1 much easier to use.

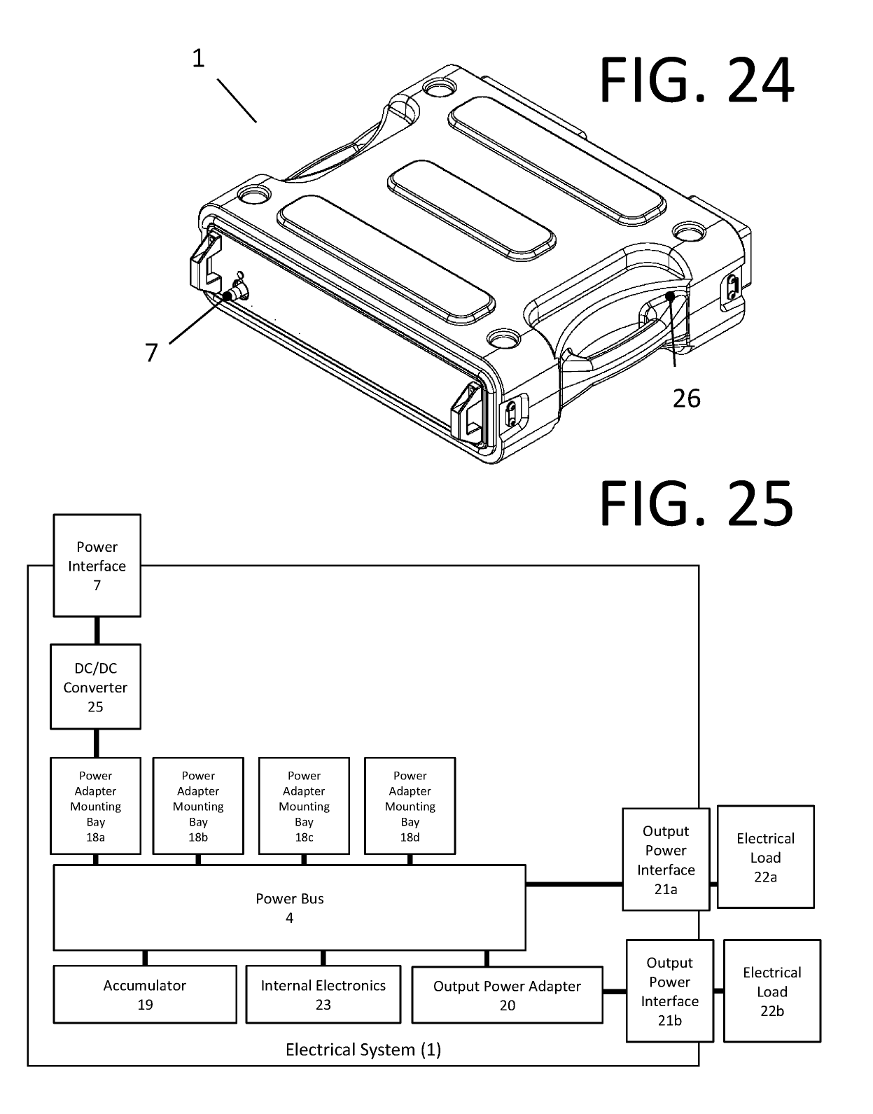

FIGS. 24 and 25 illustrate an alternative embodiment of the invention. In this embodiment, while power adapter mounting bay 18a is connected to DC/DC converter 25, power adapter mounting bays 18b, 18c, and 18d are unused, in that they are not connected to a power adapter or a power interface. While these bays may seem to be vestigial or useless, they serve a useful purpose. A modular approach to power adapters and power adapters allows an electrical system to be produced in a plurality of variants. Each variant may be similar in hardware and/or software and may feature a different number of power interfaces and power adapters. A user that does not want to pay for multiple channels of charging does not need to pay for it and can purchase an electrical system with fewer channels of charging. A charging channel refers to the a power interface or a combination of power interfaces and power adapters that bring in power from a power source or an external power adapter.

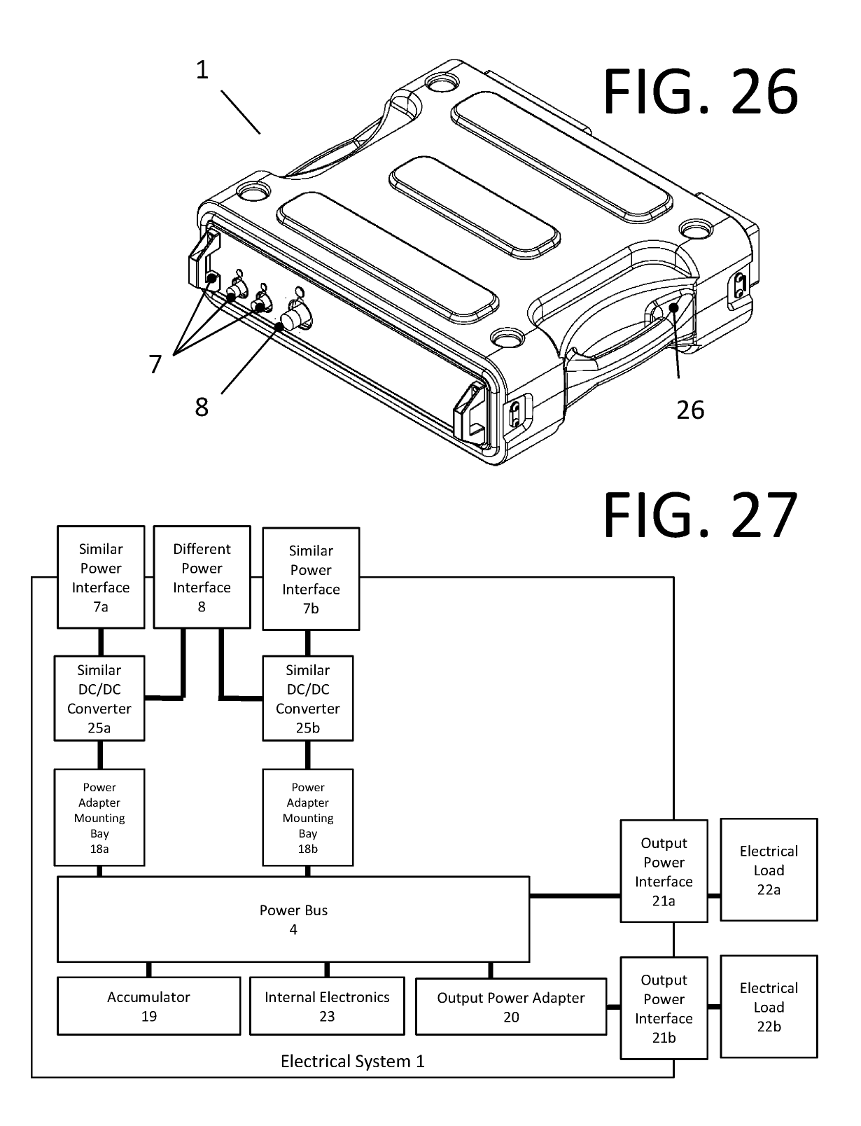

FIGS. 26 and 27 illustrate an alternative embodiment of the invention. This embodiment has a different power interface 8 along with a plurality of similar power interfaces 7a and 7b. The different power interface connects to a plurality of similar DC/DC converters 25a and 25b. For example, the similar power interfaces may each feature two wires, a positive and negative wire. The different power interface 8, may feature four wires, two positive and two negative wires. The similar power interfaces 7a and 7b may be used to connect to a power source 5 that has an amount of available power less than the available capacity of the similar DC/DC converters 25a and 25b. For example, if the DC/DC converter has a capacity of 250 W, a 100 W solar panel or a 200 W AC/DC converter may be plugged into the similar power interfaces 7a and 7b, and the similar DC/DC converters 25a and 25b would be able to take advantage of all the available power. If a 500 W AC/DC converter were attached to a single similar DC/DC converter with capacity of 250 W, then 250 W of available power would go unused.

In one embodiment, the external power adapter, for example a 500 W AC/DC converter, could attach to a plurality of similar power interfaces. In such an embodiment, each of the similar DC/DC converters would use 250 W of the available power, and more power would be used than if the external power adapter were plugged into fewer similar power interfaces.

In another embodiment, the external power adapter, for example a 500 W AC/DC converter, could connect to a different power interface. The different power interface would then in turn be connected to a plurality of similar DC/DC converters, for example a DC/DC converter with 250 W capacity. In this embodiment, each of the similar DC/DC converters would use 250 W of the available power, and more power would be used than if the external power adapter were plugged into fewer similar power interfaces. This is an advantageous configuration because a high power external adapter could be attached to the electrical system through a single connector instead of two connectors in alternative configurations without a different power interface.

A high power external adapter may be considered an external power adapter with more available power capacity than a single similar DC/DC converter. A low power external adapter may be considered an external power adapter with an amount of available power of less than or equal power to the power capacity of a single similar DC/DC converter. The present invention is advantageous in that it provides an economical and simple way to connect a wide variety of high power external adapters and low power adapters to an electrical system.

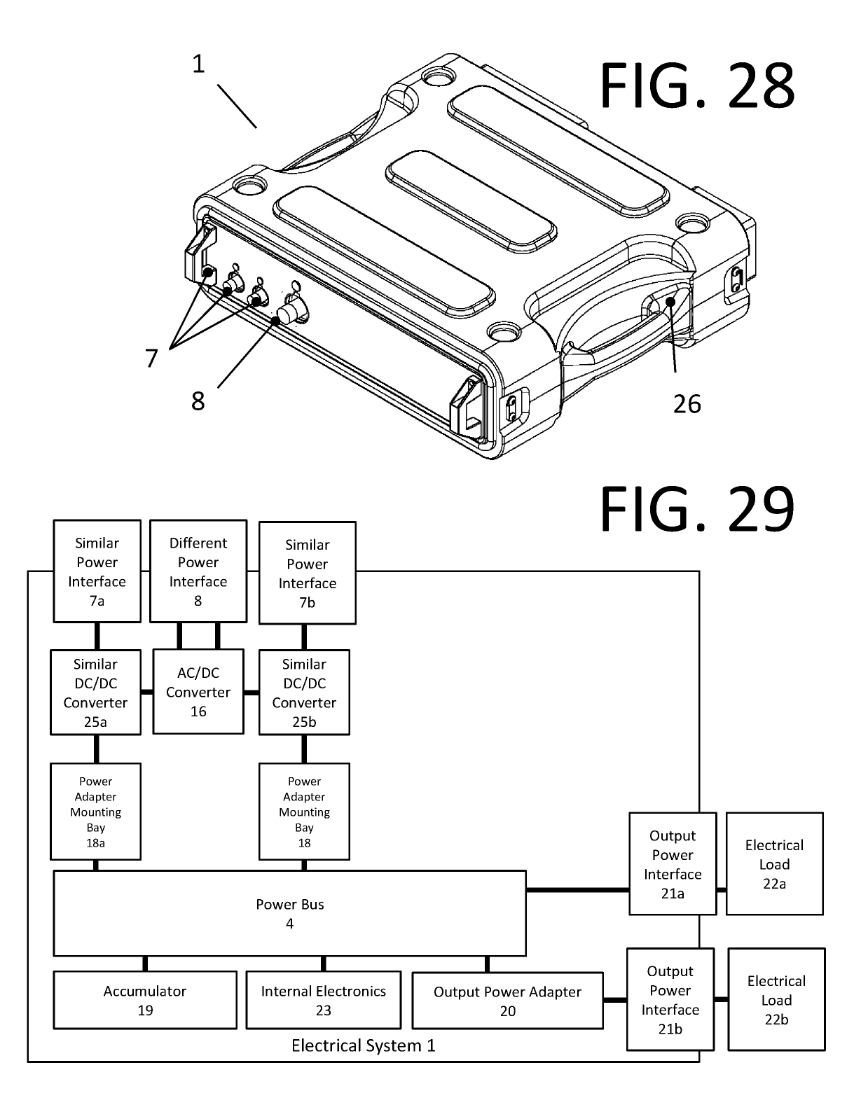

FIGS. 28 and 29 illustrate an alternative embodiment of the invention. In this embodiment, a different power interface 8 is connected to an AC/DC converter 16 which is then connected to a plurality of similar DC/DC converters 25a and 25b. For example, the different power interface may be an AC power cable or an AC power inlet. This is an advantageous configuration because it allows the electronic system to be powered off an AC source, for example a wall plug or a generator, without an external power adapter. Connecting the AC/DC converter 16 to the plurality of DC/DC converters 25a and 25b allows the AC/DC converter to be simpler and cheaper. The electrical system 1 may have an accumulator 19. In that case, it as advantageous to control the flow of power into the system. A simple AC/DC converter may not control the power. For example, it may not limit current. This functionality may be provided by the similar DC/DC converters 25a and 25b. This allows the electrical system to utilize the same hardware across a variety of power input scenarios. This also reduces the extra cost and complexity that may be required if all possible charging scenarios are handled by a unique set of hardware. In an alternative embodiment, the AC/DC converter 16 may be connected directly to the power bus 4.

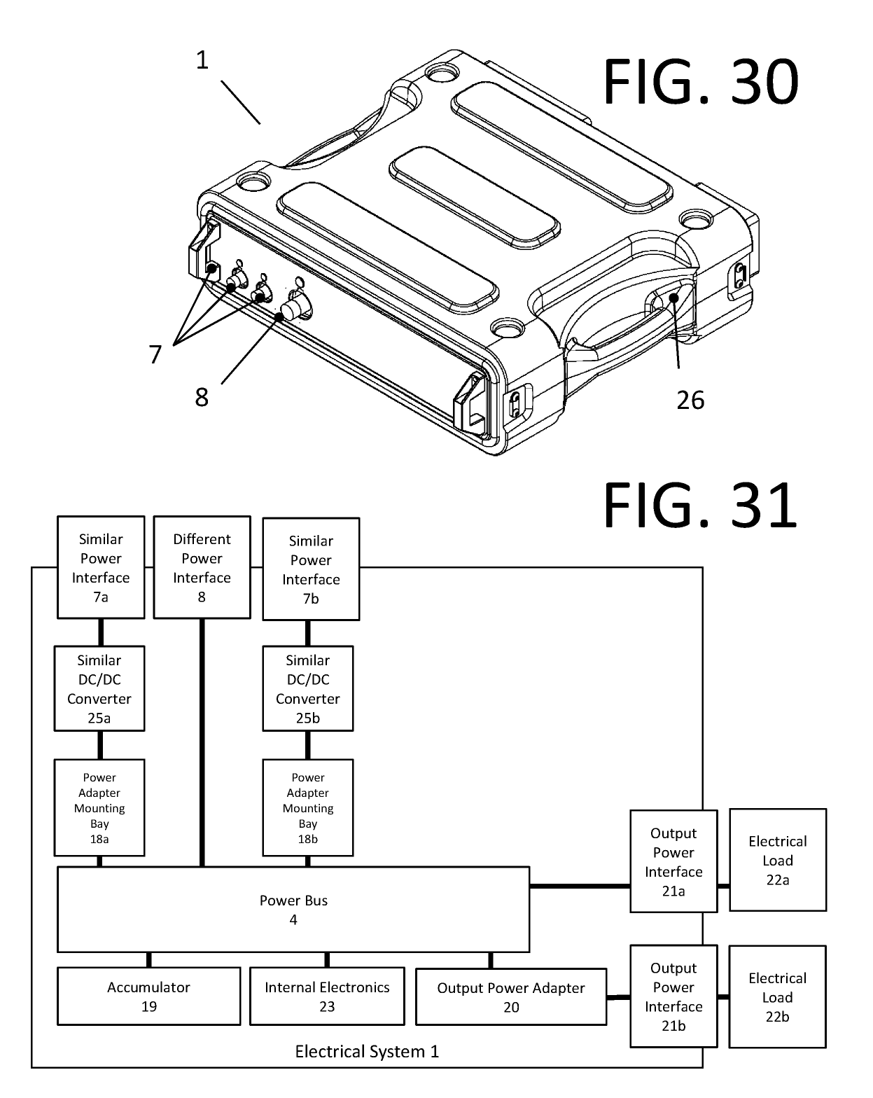

FIGS. 30 and 31 illustrate and alternative embodiment of the invention. In this embodiment, a different power interface 8 is directly connected to power bus 4. This connection facilitates the flow of energy into and/or out of the device without power conversion. One or a plurality of different power interfaces may be directly connected to power bus.

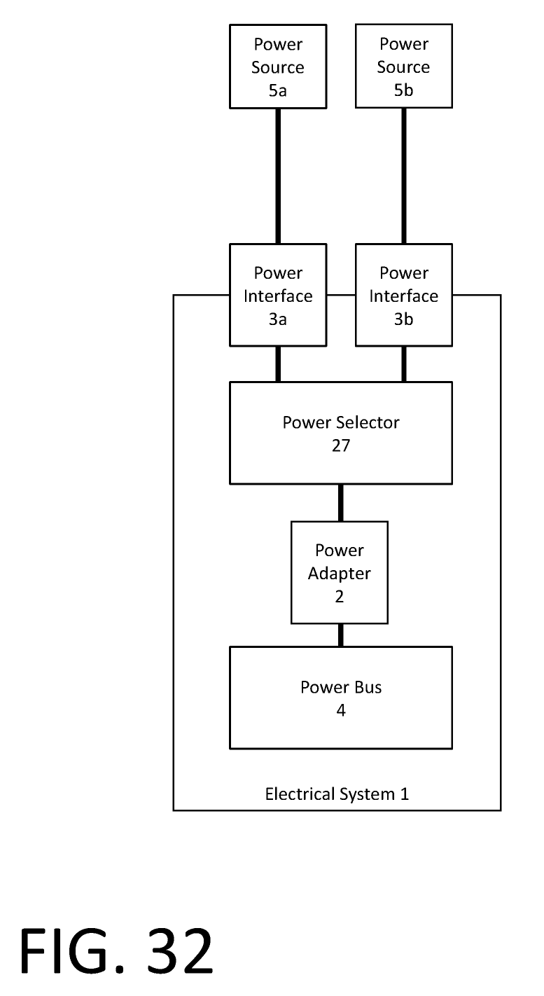

FIG. 32 illustrates an alternative embodiment of the invention. In this embodiment, a plurality of power sources 5a and 5b are connected to a single power adapter 2 through a power selector 27. The power selector automatically or manually allows for the transfer of energy from a single power interface to a power adapter while disallowing the transfer of energy from a different power interface to the power adapter. For example, the power selector 27 may be an ORing diode setup that automatically allows for power to flow from the power interface with the higher voltage. The power selector 27 could also be any electrical and/or mechanical system that can accomplish the selection function as would be known by those familiar with the field.

This embodiment is advantageous in that it would allow for two or more different power sources to be connected to the device, and the device would require a fewer number of power adapters to utilize the multiple charging sources. For example, a solar panel and an AC power source may be connected to the device at the same time. When the AC power source is available, the device would draw power from it instead of from the solar panel. When the AC power source is not available, the device would draw power from the solar panel. It is advantageous that this would require no reconfiguring between the two charging states by a user.

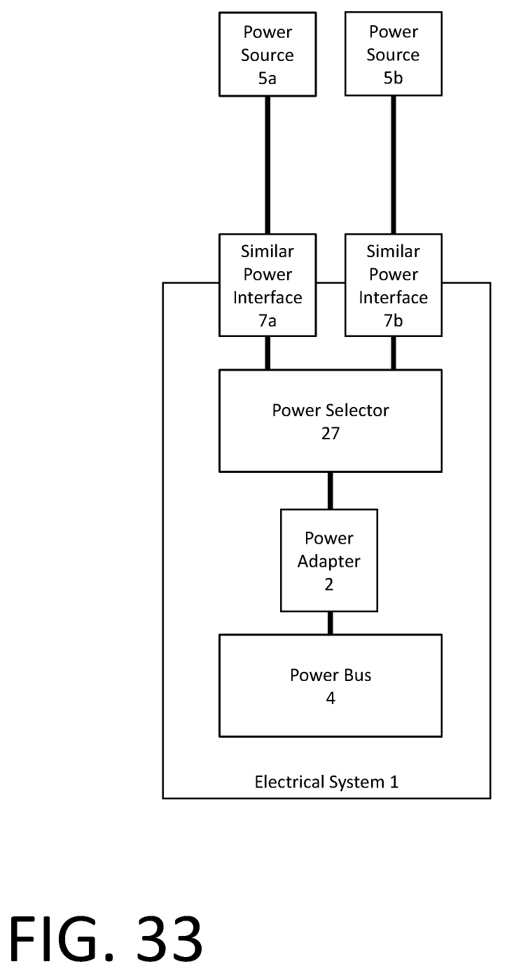

FIG. 33 illustrates an alternative embodiment of the invention. In this embodiment, two or more power sources 5 are connected to a power selector 27 through two or more similar power interfaces 7a and 7b. This is advantageous in that a user may plug any of the power sources into any of the similar power adapters and the device would function properly. This makes operating the device easier for the user.

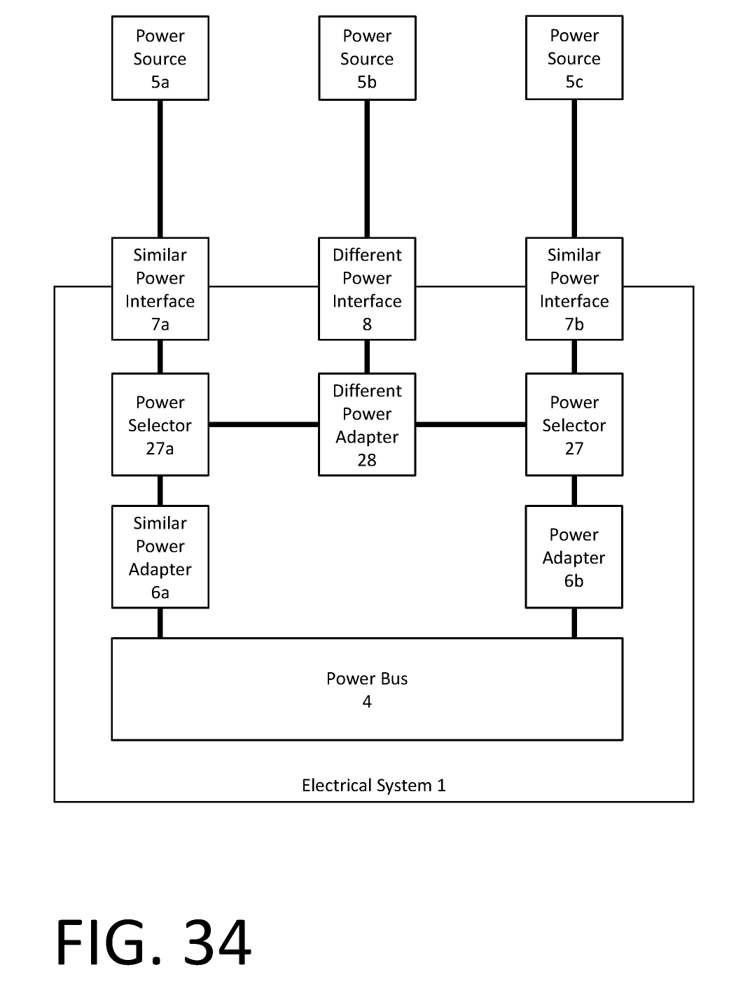

FIG. 34 illustrates an alternative embodiment of the invention. In this embodiment, a plurality of power interfaces 7a, 7b, and 8 are each connected to a different power sources and to different power adapters. The different power adapter is then connected to a plurality of similar power adapters 6a and 6b through power selectors 27a and 27b.

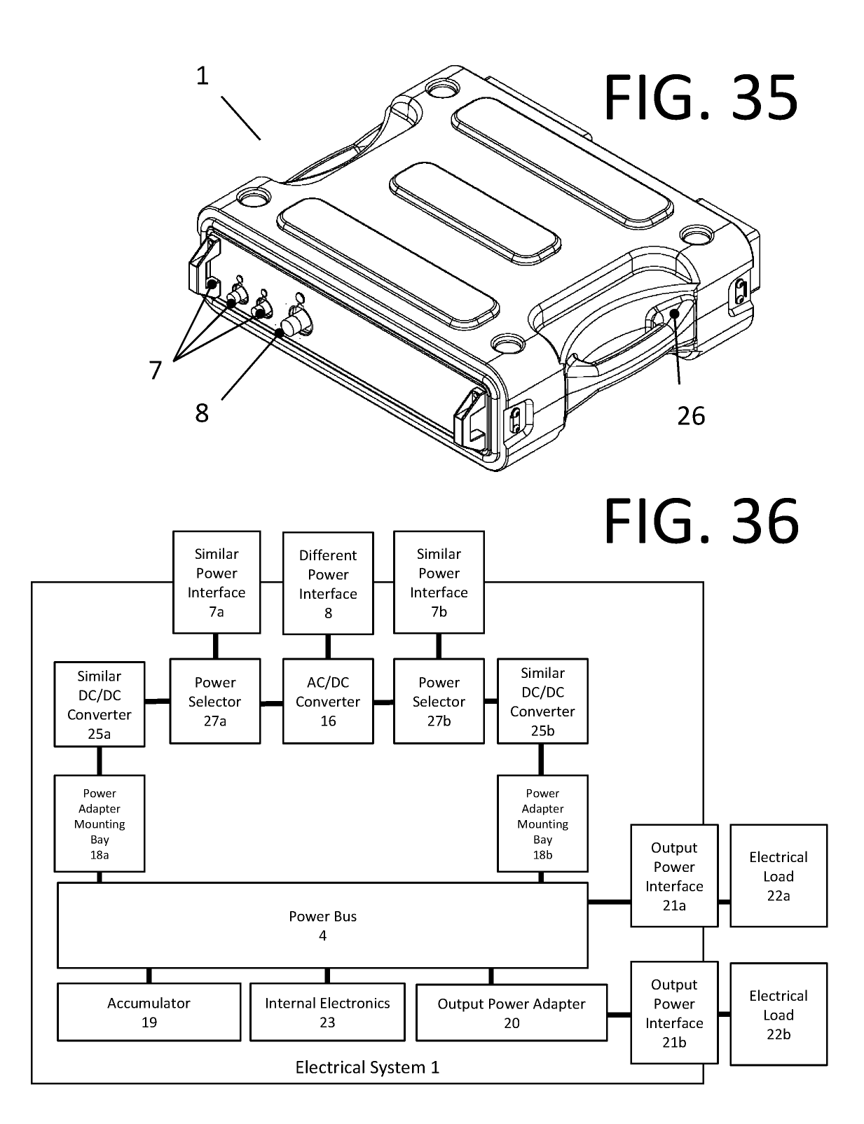

FIGS. 35 and 36 illustrate an alternative embodiment of the invention. In this embodiment, a different power interface 8 is connected to power selectors 27a and 27b through AC/DC converter 16. Similar power interfaces 7a and 7b are also connected to power selectors 27a and 27b. Power selectors 27a and 27b are then connected to power converters 25a and 25b. It is advantageous that this would require no reconfiguring between the two charging states by a user and that the device could utilize power from multiple sources with fewer components, which would lead to it being less expensive to produce, lighter, and less complex.

In this embodiment, if an AC power source is connected to a different power interface, the device could draw power from it instead of a power source connected to a similar power interface. When the AC power source is not available, the device could draw power from a power source connected to a similar power interface. It is advantageous that this would require no reconfiguring between the two charging states by a user and that the device could utilize power from multiple sources with fewer components, which would lead to it being less expensive to produce, lighter, and less complex.

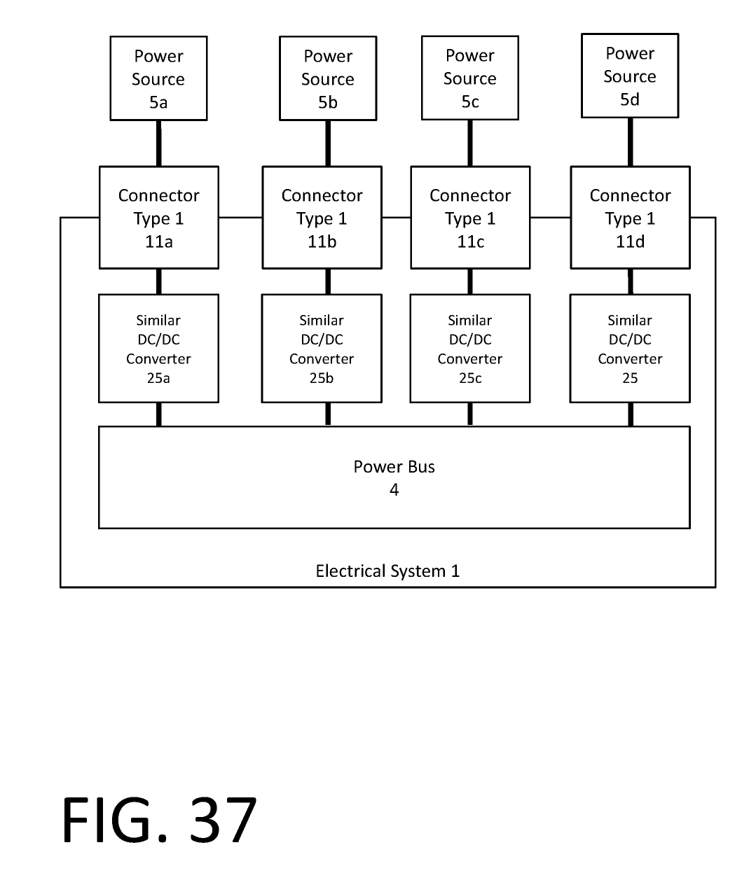

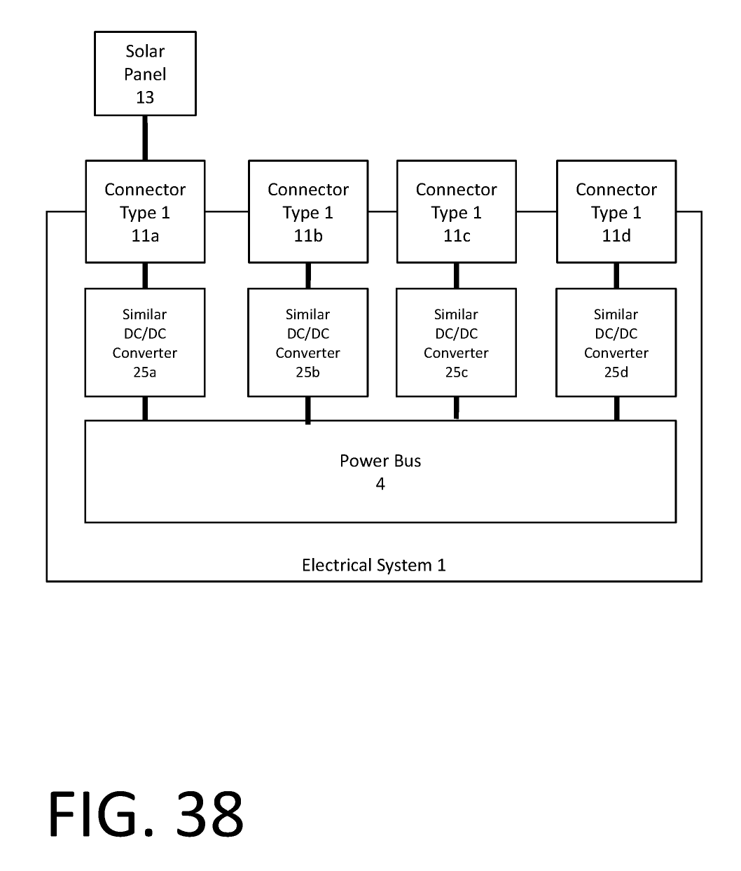

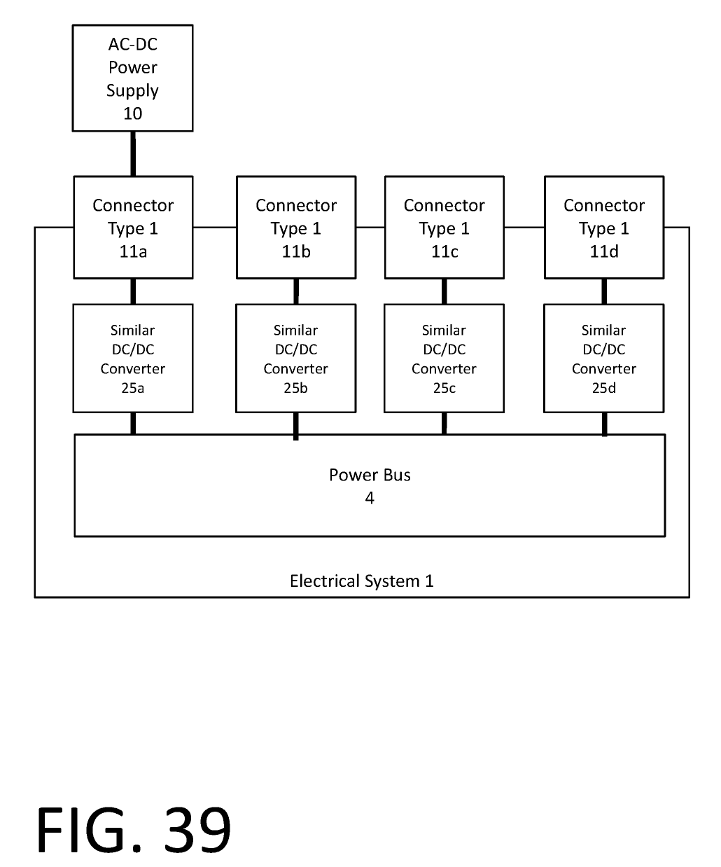

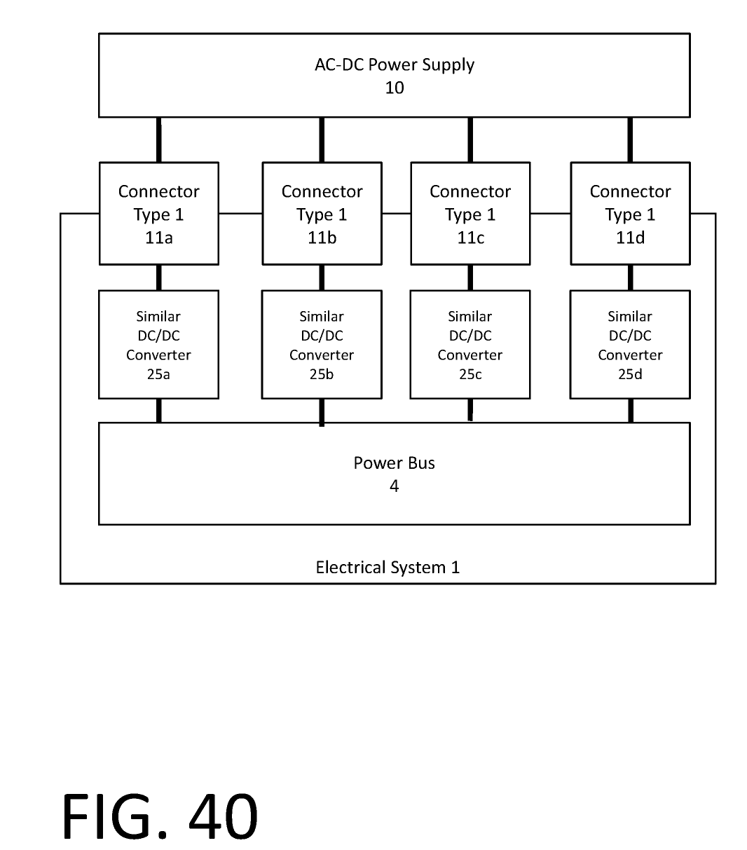

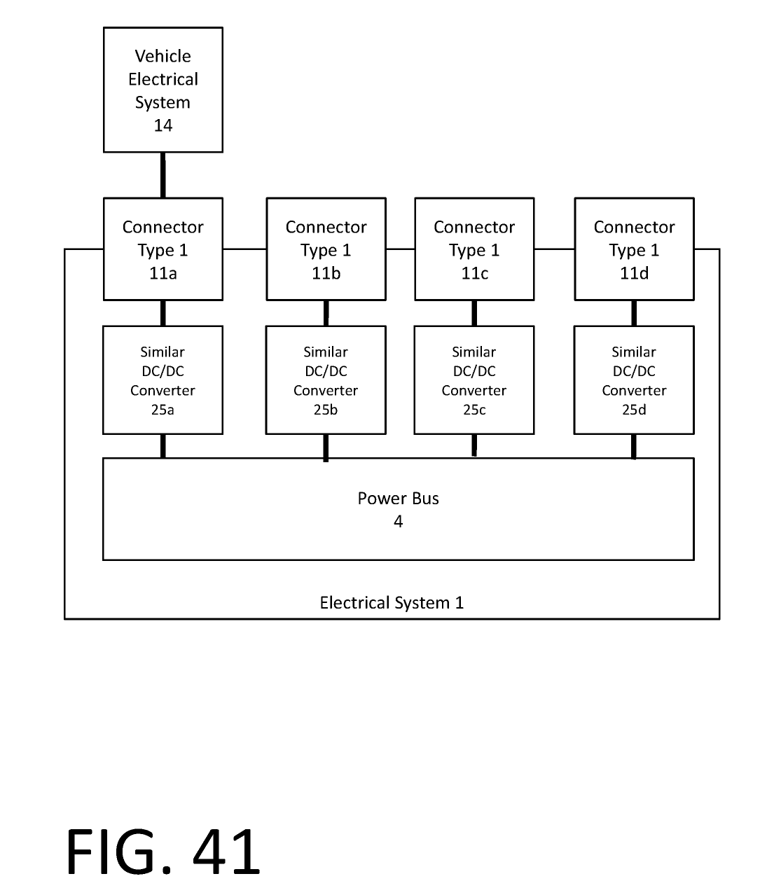

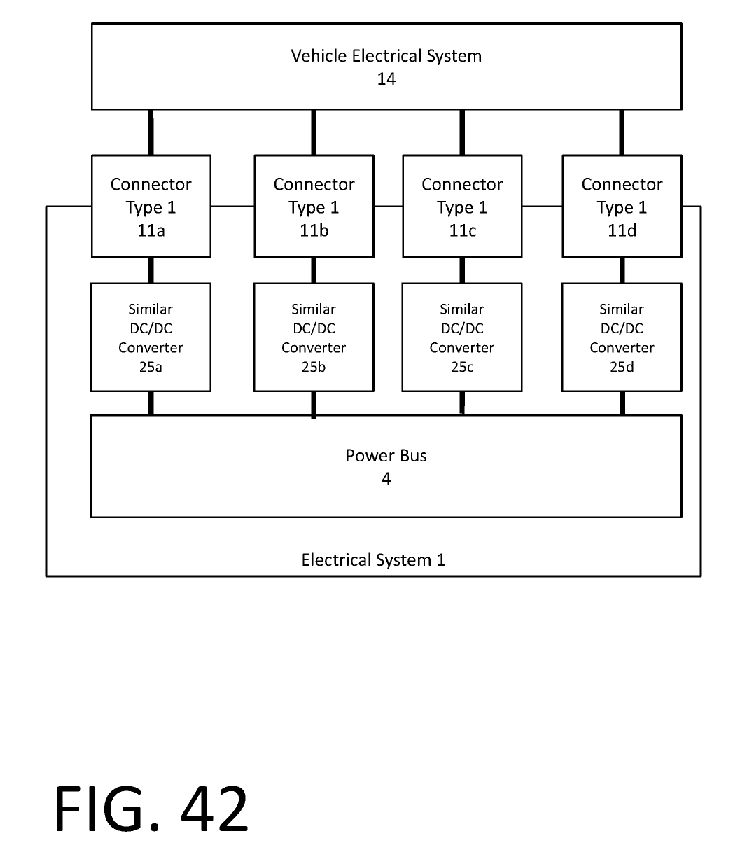

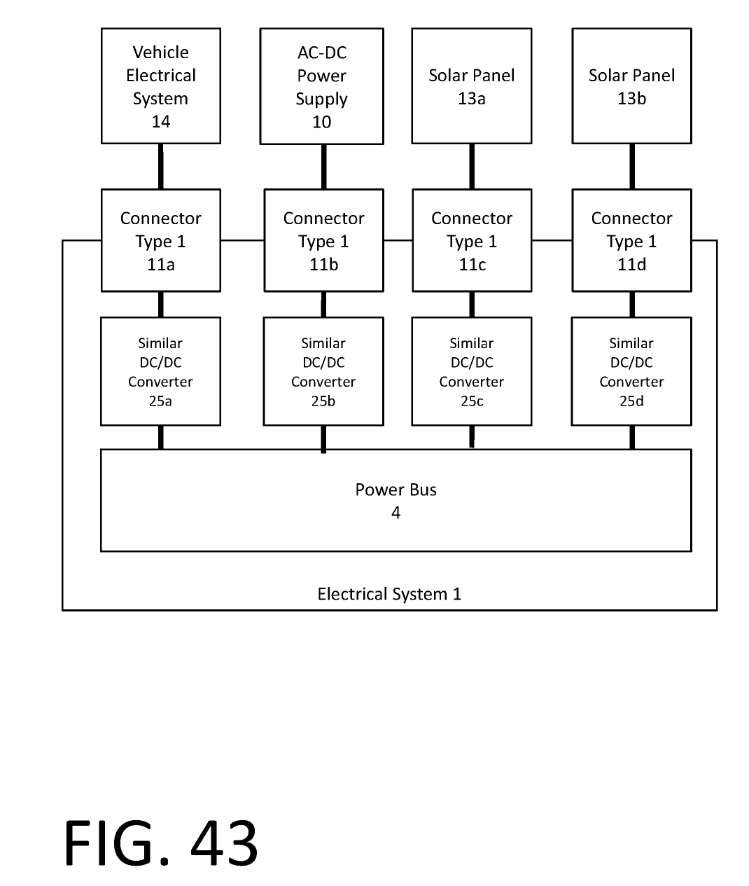

FIGS. 36 through 42 illustrate alternative embodiments of the invention. These embodiments illustrate how the present invention can support a variety of power sources by type and size with an array of identical connectors connected to a corresponding array of similar DC/DC converters.

We claim:

1. A system for supplying power to an electronic device from a plurality of different DC power sources, comprising:
a plurality of similar input power interfaces connected to the different DC power sources, wherein any of the different DC power sources may be connected to any of the input power interfaces;
a plurality of power adapters connected to the input power interfaces; and
at least one power bus connected to the power adapters.

2. The system of claim 1, wherein the different power sources are selected from the group consisting of a solar panel, a turbine, a vehicle power system, an energy storage element, an AC/DC power supply, a DC grid connection, and a DC generator.

3. (canceled)

4. (canceled)

5. (canceled)

6. The system of claim 1 further comprising a plurality of power adapter mounting bays, wherein each of the power adapters is connected to a corresponding power adapter mounting bay.

7. The system of claim 1, wherein at least one of the power adapters is a battery charger.

8. The system of claim 7, wherein the battery charger has maximum power point tracking capability.

9. The system of claim 1 further comprising at least one accumulator connected to the at least one power bus.

10. The system of claim 9, wherein the at least one accumulator is a battery.

11. The system of claim 1 further comprising at least one output power interface, wherein each output power interface is connected to a power bus.

12. The system of claim 11 further comprising at least one output power adapter, wherein each output power adapter is connected to a power bus and an output power interface.

13. The system of claim 1, wherein at least one of the different DC power sources may be connected to a plurality of the input power interfaces.

14. The system of claim 1 further comprising a plurality of different input power interfaces wherein each of the different input power interfaces is connected to power bus.

15. The system of claim 1 further comprising a plurality of different input power interfaces wherein each of the different input power interfaces is connected to a power adapter.

16. (canceled)

17. (canceled)

18. (canceled)

19. A device capable of being powered by a plurality of different DC power sources, comprising:
a plurality of similar input power interfaces connected to the different DC power sources, wherein any of the different DC power sources may be connected to any of the input power interfaces;
a plurality of power adapters connected to the input power interfaces; and
at least one power bus connected to the power adapters.

20. The device of claim 19, wherein the different DC power sources are selected from the group consisting of a solar panel, a turbine, a vehicle power system, an energy storage element, an AC/DC power supply, a DC grid connection, and a DC generator.

21. A system for supplying power to an electronic device from a DC power source, comprising:
a plurality of similar input power interfaces connected to the power source;
a plurality of power adapters connected to the input power interfaces; and
at least one power bus connected to the power adapters.

22. The system of claim 21, wherein the power source is selected from the group consisting of a solar panel, a turbine, a vehicle power system, an energy storage element, an AC/DC power supply, a DC grid connection, and a DC generator.

23. A device capable of being powered by a DC power source, the device comprising:
a plurality of similar input power interfaces connected to the power source;
a plurality of power adapters connected to the input power interfaces; and
at least one power bus connected to the power adapters.

24. The device of claim 23, wherein the DC power source is selected from the group consisting of a solar panel, a turbine, a vehicle power system, an energy storage element, an AC/DC power supply, a DC grid connection, and a DC generator.
